(19) United States
(12) Patent Application Publication
(10) Pub. No.: US 2019/0337861 A1
(43) Pub. Date: Nov. 7, 2019

(54) AQUEOUS, POURABLE, FOAMABLE, PUMPABLE AND SETTABLE DISPERSIONS AND USE THEREOF TO PRODUCE POROUS, MINERAL LIGHTWEIGHT CONSTRUCTION MATERIALS

(71) Applicant: WIND PLUS SONNE GMBH, Gronau (Westf) (DE)

(72) Inventors: Gregor LUTHE, Gronau (Westf.) (DE); Karl ROBITZER, Munster (DE); Heinz HOFFMANN, Bayreuth (DE)

(21) Appl. No.: 16/344,789

(22) PCT Filed: Oct. 20, 2017
(86) PCT No.: PCT/EP2017/001230

§ 371 Date: Apr. 24, 2019

(30) Foreign Application Priority Data
Oct. 25, 2016 (DE) 10 2016 012 746.5

(51) Int. Cl. C04B 38/10

(52) U.S. Cl. CPC C04B 38/10; C04B 2111/2092

(57) ABSTRACT

An aqueous, pourable, foamable, pumpable and settable dispersion, its use to produce a porous, mineral lightweight construction material, and a process for producing the dispersion, are described. The dispersion contains cement and/or zinc phosphate cement or a mixture of cement and/or zinc phosphate cement and a Silicate and/or an aluminosilicate with an alkaline or acidic activator for producing a geopolymer and/or a geopolymer, containing a Surfactant, 0.01 to 5 wt %, relative to the dry mass of the dispersion, of modified and/or unmodified natural potato starch, rice starch, corn starch, and wheat starch and of cooked and/or raw, comminuted pieces of grains, potatoes and rice, and water having a hardness of >3.2 mmol/1. Also described herein are the porous, mineral lightweight construction material and its use. The construction material contains, relative to a given lightweight construction material, 50 wt % to 95 wt % of a cement and/or a zinc phosphate cement or a mixture of a Silicate and/or of an aluminosilicate with an alkaline or acidic activator for producing a geopolymer and/or a geopolymer with cement and/or zinc phosphate cement, 0.001 wt % to 3 wt % of a Surfactant, and 0.01 wt % to <10 wt % of potato starch, rice starch, corn starch and/or wheat starch of cooked and/or raw, comminuted pieces of grains, potatoes and rice.

The present invention concerns aqueous, pourable, foamable, pumpable and settable dispersions.

Additionally, the present invention relates to the use of the aqueous, pourable, foamable, pumpable and settable dispersions for the preparation of porous, expanded open cell or closed cell, hydrophobic or hydrophilic, mineral lightweight construction materials.

Moreover, the present invention concerns a process for the preparation of for porous, expanded open cell or closed cell, hydrophobic or hydrophilic, mineral lightweight construction materials from the said aqueous, pourable, foamable, pumpable and settable dispersions.

Additionally, the present invention relates to porous, expanded open cell or closed cell, hydrophilic or hydrophobic, mineral lightweight construction materials.

Last but not least, the present invention relates to composite materials on the basis of the said porous, open cell or closed cell, hydrophilic or hydrophobic, mineral lightweight construction materials.

### BACKGROUND OF THE INVENTION

The prior art cited in this application is incorporated by reference and becomes part of the application.

Aerated concrete for use as a lightweight construction material is known since the 19th century and was patented in the year 1924. This patented aerated concrete is nowadays known under the trade name Ytong. Aerated concrete is a steam hardened, compacted construction material with a bulk density of 200 to 800 kg/m³ and is manufactured from the raw materials burned lime, water and quartz sand. By way of the addition of water, the raw materials are mixed to yield a plaster. Generally, 400 to 3000 g of aluminum powder and/or paste per 1 m³ of aerated sediment are added to the finished suspension. The finished plaster is now transferred to a receptacle, wherein the metallic, fine-particle aluminum in the alkaline plaster suspension produces hydrogen. This way, numerous small gas bubbles develop, which gradually expand the setting mixture. The final volume is reached after 15 to 50 minutes. These blocks are cut with wires to the desired brick- or building material sizes. By way of hardening the material in special vapor pressure boilers, also known as autoclaves, the material reaches its final applicational properties at temperatures of 180° C. to 200° C. in water vapor under saturated steam of 10 to 12 bar after 6 to 12 hours. Chemically, aerated concrete consists, in the end, mostly of the natural mineral Tobermorite, albeit in synthetic form. The production process allows for the optional production of reinforced or unreinforced construction components, however, it is disadvantageous that a comparatively large amount of energy is consumed by the porous concrete by the hardening in the water vapor during the production. An additional drawback of the production process is that the released hydrogen necessitates extensive safety measures. Moreover, the heat conductivity of the finished aerated concrete gradually changes with time because the hydrogen diffuses out of the pores and is replaced by air. Last but not least, the average values of the compressive strength are from 2.5 to 10 N/mm², which must still be optimized.

In contrast to aerated concrete, porous concrete or foamed concrete is not prepared by using hydrogen and aluminum which both pose safety concerns.

The Korean patent application KR 2013 093015 A discloses a porous, isolating lightweight concrete which can dampen footfall sound on floors. This lightweight concrete is prepared by using porous ethylene vinyl acetate chips and perlite. The production process comprises mixing of from 40 to 80% by weight of pulverized ethylene vinyl acetate chips, 20 to 60% by weight of high temperature plastic perlite having a particle size of 30 to 100 μm, mixing of from 2 to 10% by weight of the resulting mixture with 100% by weight cement, preparing a foaming agent by adding of from 3 to 15% by weight of a 5% aqueous polyvinyl alcohol solution and 3 to 15% by weight soymilk to 100% by weight of the sodium lauryl sulfate solution and mixing of 0.5 to 3% by weight of the foaming agent with 100% by weight of the cement.

A concrete additive is known from the Chinese patent application 105016648 A which contains the following components: 5 to 20 parts by weight of a water reducing additive, 55 to 80 parts by weight of water glass, 1 to 2 parts by weight of an early solidification agent, 2 to 3 parts by weight of hydroxymethyl propyl cellulose, 1 to 2 parts by weight of sodium lauryl sulfate and 10 to 25 parts of water. The additive is used for preparing a composite block from milled porous concrete scrap and foamed concrete, to which the additive has been added.

Luca Industries International GmbH offers a foamed concrete or porous concrete under the trade trademark LithoPore™. A foaming agent on the basis of enzymes is supposed to be used as the foaming agent or the surfactant.

A free-flowing porous lightweight plaster is offered by Heidelberger Beton HeidelbergCement Group under the trademark Poriment™. However, an embodiment contains styropor (expanded polystyrene foam plastic beads).

These processes avoid the high energy consumption and the development of hydrogen during the preparation of Ytong™, however, the products must be improved further with regard to their mechanical and isolating properties.

A molding material for the preparation of porous concrete containing 30 to 77% by weight of Portland cement, 0.001 to 2.5 parts by weight of metal containing carbon nanotubes, 0.4 to 0.7% by weight of a foaming agent and water is known from the Russian patent RU 2287505 C1. The molding material can contain 0 to 30% by weight of quartz sand as a filler.

A process for the preparation of starting products for porous concrete is known from the Russian patent RU 2472753 C1. A dry mixture of 500 DO Portland cement and quartz sand is prepared in the process. The mixture is pre-dried and milled until a specific surface of not more than 2400 cm²/g is achieved. Simultaneously, water and an additive is added to the Portland cement. The additive is a combination of aluminum silicate microspheres and one-layer or multiple-layer carbon nanotubes in the ratio of 1:10. The aqueous solution thus obtained is added to the dry mixture and mixed. Thereafter, aluminum powder and sodium hydroxide are added and mixed. A starting product is obtained which contains 20 to 75% by weight DO Portland cement, 20 to 75% by weight of quartz sand, the additive, 0.007 to 0.5% by weight of aluminum powder, 0.0005 to 0.005 sodium hydroxide and as the remainder water. Polypropylene or metal fibers can also be added to the starting product.

The starting product for the preparation of porous concrete is known from the Russian patent RU 2524361 C2. The starting product contains Portland cement, quicklime, dried scrap from blocks of porous cement, aluminum powder, a surfactant, a water reducing agent, multi-layer carbon nanotubes, the surface of which is functionalized with oxygen-containing groups, and water. In order to disperse the carbon nanotubes, the starting product is treated with ultrasonic sound.

However, the process and the products still exhibits the same disadvantages as the preparation of Ytong™.

A mold having a lightweight structure which is rich of pores and has a matrix on the basis of a gel and/or a melt of water containing starch or starch containing plant material and additives is known from the Austrian patent AT 398754 B, the said mold containing, based on its dry mass
30-90% by mass of at least one inorganic hydraulic binder,
70% by mass of at least one starch and/or at least a starch as the essential component of the plant material, wherein the starch or the starch containing plant material can be substituted up to 60% by mass by other melting or gelling biopolymers selected from the group consisting of dextrin, cell wall polysaccharides, collagens and proteins.

Moreover, the lightweight structure can contain a reinforcement component, an inorganic filler and/or a latent hydraulic binder, an additive, a dye and/or a biocide.

The inorganic binder is selected from the group consisting of cements, cement clinker, hydraulic line and gypsum. Gypsum is particularly preferably used.

The reinforcement component is selected from the group consisting of biogenic vegetable, mineral or synthetic fibers. Preferably, ground wood pulp, wood chips, water containing plant parts, pulp and/or paper and/or cardboard materials as well as minerals, clinker and/or glass fibers are used.

The inorganic filler is selected from the group consisting of stone flours is also and silicates and the latent hydraulic binders such as clinker, ashes, fly ash, fly dust, volcanic ashes, trass and puzzolan.

The molds having the lightweight structure are prepared by melting their components under increased mechanical shear stress and by extruding under increased pressure and increased temperatures, after which the resulting melt is expanded by pressure release immediately after leaving the extruder.

The drawback of the known molds having a lightweight structure is that they do not reach the mechanical strength of porous concrete. Moreover, because of their high content of from 10-70% by mass of starch, they are not stable against high temperatures and can even be damaged by fires to a degree that they decompose or even burn themselves. Due to the process of their preparation, the number of the feasible forms of the known molds is severely restricted.

A process for the preparation of foam and expanded masses or extended bodies from a mixture of raw materials with a solid of alumosilicates which, after alkaline activation yield polymeric structures and/or three-dimensional net structures and are thereby hardened is known from the German unexamined laid-open patent application DE 10 2014 003 104 A1. The alkaline activation is initiated by mixing the solid containing the alumosilicates with the activator and by homogenizing, wherein, however, before the complete hardening of the geopolymer matrix, an expansion takes place. As the alumosilicates, natural and synthetic alumosilicates, metakaolin, granulated slag sand flour, microsilica, trass flour, oil shale, fly ash, wood oven clinker, aluminum containing silica flour, puzzolans, basalts, clays, marls, andesite, diatomaceous earths, kieselghur, zeolites, brick powder and/or smelting chamber sand are used. The expansion and foaming take place by the sudden and rapid evaporation of water. Thereafter, the foam is set by heating or hardening in a dryer, in an oven or in a revolving oven, by extremely hot surfaces, highly heated forms, open flames, confocal radiation dryers and/or microwaves. The process can also be carried out as a thermal hydraulic process on an extruder. The thermal hydraulic process can be supported by additives having the so-called popcorn effect such as starches from plant materials such as corn or potatoes.

It cannot be derived from the unexamined laid-open patent application in which amounts the starches are used. Moreover, it is to be expected that they are destroyed during the hardening or the burning of the foamed molds due to the process of preparation and that the number of the feasible forms of the known molds is severely restricted.

### THE OBJECT OF THE INVENTION

It has been the object of the present invention to provide new aqueous dispersions for the preparation of porous, open cell and closed cell, hydrophilic or hydrophobic, mineral lightweight construction materials, in particular porous concrete, which dispersions can be easily and safely prepared and can be advantageously widely varied in their application-technical property profile. The new aqueous dispersions should be non-toxic, storage-stable, transportable, pumpable, flowable, foamable and settable and should be processed rapidly and with a minimum expenditure of energy to yield the porous, open cell or closed cell hydrophilic or hydrophobic, mineral lightweight construction materials.

The resulting, porous, mineral lightweight construction materials, in particular the porous concrete, should have a particularly low density, a high mechanical stability and a wide applicability exceeding the hitherto known applications.

### The Inventive Solution

Therefore, the aqueous, pourable, foamable, pumpable and settable dispersions have been found, which dispersions contain
at least one kind of cement and and/or at least one kind of a zinc phosphate cement or a mixture M of (i) at least one kind of cement and/or at least one kind of a zinc phosphate cement and (ii) at least one silicate and/or at least one alumosilicate, each of which with at least one alkaline or acidic activator for the preparation of a geopolymer and/or at least one geopolymer in a weight ratio of (i):(ii)=1000-0.1,
at least one surfactant,
0.01 to <10% by weight, based on the dry mass of the dispersion, of at least one kind of modified and/or non-modified natural homoglycanes selected from the group consisting of potato starch, rice starch, cornstarch and wheat starch and of cooked and/or raw crushed or shredded pieces of grains, potatoes and rice, and
water of a water hardness of >3.2 2 mmol/L.

Hereinafter, the new dispersion will be referred to as “the dispersion of the invention”.

Moreover, the use of the dispersion of the invention for the preparation of porous, open cell or closed cell, hydrophilic or hydrophobic, mineral, lightweight building material, in particular porous concrete, of plaster, of pouring materials or of 3-D printing materials has also been found. Additionally, the new process for the preparation of porous, mineral lightweight construction materials, in particular porous concrete, from the dispersions of the invention has been found, which processes carried out by

(I) preparing at least one aqueous, pourable, foamable, pumpable and settable dispersion by mixing of at least
at least one kind of cement and/or at least one kind of the zinc phosphate cement or a mixture M of (i) at least one kind of cement and/or at least one kind of zinc phosphate cement and (ii) at least one silicate and/or at least one alumosilicate, each of which with at least one alkaline or acidic activator for the preparation of a geopolymer and/or at least one geopolymer in a weight ratio of (i):(ii)=1000-0.1,
at least one surfactant,
0.01 to <10% by weight, based on the dry mass of the dispersion, of at least one kind of modified and/or non-modified natural homoglycanes, selected from the group consisting of potato starch, rice starch, cornstarch and wheat starch and of cooked and/or raw shredded pieces of grain, potatoes and rice, and
water of a water hardness >3.2 mmol/L,

in a mixing unit under atmospheric pressure.

Hereinafter, the new process will be referred to as the “process of the invention”.

Furthermore, the lightweight construction materials according to the present invention have been found, which contain, based on a given lightweight building material,
50% by weight to 99.989% by weight of at least one kind of cement and/or at least one kind of zinc phosphate cement or a mixture M of (i) at least one kind of cement and/or at least one kind of zinc phosphate cement and (ii) at least one silicate and/or at least one alumosilicate, each of which with at least one alkaline or acidic activator for the preparation of geopolymer and/or at least one geopolymer in a waits ratio of (i):(ii)=1000-0.1,
0.001% by weight to 3 percent by weight of at least one surfactant, and
0.01% by weight to <10% by weight of at least one kind of modified and/or non-modified natural homoglycanes, selected from the group consisting of potato starch, rice starch, cornstarch and wheat starch and of cooked and/or raw, shredded pieces of grain, potatoes and rice.

Furthermore, the use of the lightweight construction materials according to the present invention for the control of mold, algae and bacteria inside and outside of buildings, bridges, paths and streets, as molds and building parts killing mold and bacteria of all kinds, floating screeds, floors, insulating materials, potting compounds, substituents for foams made from polyurethanes, expanded polystyrene (EPS) and an extruded polystyrene hard foam (XPS), fundaments, submarine or underwater buildings, foam injections for cavity layers, isolating adjustment materials, installations for floor heating, installations for flat roofs, inside and/or outside plasterwork, blocks and/or liquid materials, stones and/or molds, supporting and non-supporting elements, sheetrock substitute, footfall sound protection, fire protection, radiation protection, interior work, facing, walls, ceilings, reinforced ceiling plates, wall tiles, roof plates, lintels, U-bowls, roller shutter boxes, decorative elements, heat isolation compounds, isolation compounds for walls with screwed on planking, door fillings for fire protection doors, sandwich construction techniques and encapsulations, hollow articles, leveling compounds, fillers, linings, underfillings, Lego™-principal systems, building parts which do not green upon weathering for many years, isolating walls against electromagnetic radiation and/or magnetic fields, as raw materials for the preparation of novel cements in accordance with the “cradle to cradle”-principle, for the prevention of thermal bridges and cold spots, as well as for the preparation of composite materials has been found.

Last but not least, the composite materials were found which comprise
at least one layer and/or at least one core of at least one of the porous, open cell or closed cell, hydrophobic or hydrophilic lightweight construction materials prepared in accordance with the claims 8 to 10, and/or at least one porous, open cell or closed cell, hydrophilic or hydrophobic, mineral lightweight construction materials according to one of the claims 11 to 13,
at least one layer and/or at least one coating, containing or consisting of materials, selected from the group consisting of non-reinforced and glass fiber reinforced, carbon fiber reinforced, metal fiber reinforced, textile fiber reinforced, natural fiber reinforced and straw fiber reinforced as well as with plastic matting, metal matting, glass matting, textile matting and natural fiber matting and nanoparticles and nanofibers reinforced wet brick earths, dried brick earths, fired brick earths, wet clays, dried clays, fired clays, tar, bitumen, natural asphalt, mineral waxes, ozocerite, montan wax, varnishes and lacquers, thermoplastic and thermoset polymers, papers, cardboard materials, cardboards, sheetrock, gypsum cardboard, lumber, cork, sheet metal, glass plates, gypsum plates and layers of low melting glasses as well as composites of at least two of the said materials.

### Advantages of the Invention

In view of the prior art it was surprising and it could not be foreseen by the skilled artisan that the object of the invention could be solved by the dispersions of the invention, the process of the invention, the uses of the invention and the composite materials of the invention.

It was in particular surprising that the dispersions of the invention were not inflammable, non-toxic, foamable, pumpable and settable and preserved resources and could be prepared, stored and transported in a simple manner. In this regard it must be underlined that the resulting foams were particularly stable.

Furthermore, it was surprising that the dispersions of the invention could prepared in situ and could be poured to yield porous mineral lightweight construction materials, in particular porous concrete. Moreover, colored, biocidal and non-greening lightweight construction materials of the invention, in particular porous concrete, could be prepared from the dispersions of the invention. In the process, the density and the consistency of the lightweight construction materials of the invention could be varied by way of the stirring time, the stirring speed and/or the amount of gas and/or the size of the bubbles.

The used lightweight construction materials of the invention or the scrap of the lightweight construction materials could be advantageously used for the preparation of the dispersions of the invention so that a “cradle to cradle”-technology could be created.

Moreover, it was surprising that the lightweight construction materials of the invention, in particular the porous concrete, prepared from the dispersions of the invention exhibited no sharp corners or edges and, therefore, were gentle for the human skin.

It was in particular surprising that the dispersions of the invention and, therefore, also the lightweight construction materials of the invention prepared there from, in particular the porous concrete, could be cheaply produced. The lightweight construction materials of the invention, in particular the porous concrete, could be prepared in reproducible quality with or without foaming agents and were thermally isolating, static, noise retardant, free of pesticides and non-smelling and could be nailed, screwed and abraded. They were even swimming on water and were not attacked by algae and/or bacteria and other microorganisms.

Last but not least, it was surprising that the lightweight construction materials of the invention could be prepared from the dispersions of the invention at low temperatures without the help of pressure.

It was not necessary to use a hot steam pressure chamber for the preparation of the porous mineral lightweight construction materials which constitutes another essential advantage, because the drying at the air or in an oven at a temperature below 100° C., optionally under reduced pressure, were sufficient. Freeze-drying or drying with microwave radiation could also be used.

Finally, it was surprising that the dispersions of the invention and the lightweight construction materials of the invention were not toxic. Thus, when they had to be shredded and disposed of after the demolition of a building, the small sized and rod shaped demolition products contain no small size aluminum which was an exceptional advantage. The lightweight construction materials of the invention could therefore be used for the creation of new cements quite in terms with the “cradle to cradle”-principle.

Moreover, the lightweight construction materials exhibited favorable vapor diffusion properties.

Additional advantages and advantageous uses of the dispersions of the invention and of the lightweight construction materials of the invention flow from the following description and the Examples.

### DETAILED DESCRIPTION OF THE INVENTION

The present invention is directed to dispersions for the preparation of foamed, open cell and closed cell, hydrophilic or hydrophobic, mineral lightweight construction materials. In particular, the present invention is directed to dispersions for the preparation of porous concrete.

Porous concrete or aerated concrete is a comparatively lightweight, highly porous mineral, open cell a close sell, hydrophilic or hydrophobic building material on the basis of lime chalk, lime cement, clay or cement mortar or on the basis of mixture of at least two of these mortars which are made porous by expansion. The customary porous concrete is subjected generally to the vapor setting, which, however, is not necessary in the case of the porous concrete prepared from the dispersions of the invention.

Other than the designation “porous concrete” might suggest, it is not a matter in the sense of the definition because porous concrete has no aggregates such as sand or grit. If finely milled quartz containing sand, i.e. sand flour, is used as a raw material, it participates to a large extent in the chemical reactions.

The dispersions of the invention contain at least one, in particular one kind of cement. This can be lime chalk mortar, lime cement mortar or cement mortar. Portland cement is particularly preferably used.

In the alternative, the dispersions of the invention contain at least one zinc phosphate cement which can be prepared from zinc oxide, magnesium oxide, calcium fluoride silicon dioxide, aluminum oxide and orthophosphoric acid.

It is also possible to use a mixture of at least one of the aforesaid cements and at least one zinc phosphate cement in an additional embodiment of the dispersion of the invention.

In still another embodiment of the dispersion of the invention, a mixture M consisting of (i) at least one kind of cement and/or at least one kind of a zinc phosphate cement and (ii) at least one silicate and/or at least one alumosilicate each with at least one alkaline or acidic activator for the preparation of the geopolymer and/or at least one geopolymer in a weight ratio (i):(ii)=1000-0.1, preferably (i):(ii)=1000-1 and in particular of 1000-10 can be used.

Preferably, the at least one silicate and/or the at least one alumosilicate is selected from the group consisting of natural alumosilicates, waterglass, kaolinite, metakaolin, slag sand flour, microsilica, trass meal, oil shale, fly ash, woodstove slack, aluminum containing silicate flour, puzzolans, basalt, limes, marl, andesites, diatomaceous earth, infusorial earth, zeolites, brick powder and smelting chamber sand.

Preferably, the at least one alkaline activator is selected from the group consisting of sodium waterglass, potassium waterglass, lithium waterglass, sodium hydroxide, sodium hydroxide solution, sodium carbonate, potassium carbonate, alkaline sulfate, sodium meta-silicate and lime milk.

Preferably, the at least one acidic activator is selected from the group consisting of phosphoric acid, fruit acids and humic acids.

Preferably, the at least one geopolymer is selected from the group consisting of a poly(siloxanate) (Si:Al=1:0), a poly(sialate) (Si:Al=1), a poly(sialate-multisiloxanate) (Si:Al=2), a poly(calciumsialate) (Si:Al=1, 2, 3), a poly(sialate-multisiloxanate) (1<Si:AL<5), a poly(siloxanate)(Si:Al>5), a geopolymer on the basis of fly ash, a geopolymer on the basis of iron sialate, a geopolymer on the basis of aluminum phosphate and an organic-mineral geopolymer.

The content of the dispersions of the invention of at least one kind of cement, of at least one kind of zinc phosphate cement, of the said mixture of at least one kind of cement and at least one kind of zinc phosphate cement as well as of the mixture M can vary widely and, therefore, can be excellently adjusted to the requirements of each case, in particular to the requirements, which are demanded from the application-technological properties of the porous, mineral lightweight construction materials of the invention, in particular the porous concrete, prepared from the dispersions of the invention. Preferably, the content is of from 50 to 99.989% by weight, more preferably of from 55 to 99.9% by weight and in particular of from 60 to 99% by weight, each based on the dry mass of a given dispersion of the invention.

The additional essential component of the dispersions of the invention is at least one surfactant. It is possible to use two or more surfactants.

Preferably, the at least one surfactant is selected from the group consisting of amphoteric surfactants, bio surfactants, bola-shaped surfactants, co-surfactants, protein surfactants, fluorine surfactants, gemini-surfactants, anionic surfactants, cationic surfactants, non-ionic surfactants, perfluoro surfactants, polymer surfactants, silicon surfactants and triton surfactants. As regards the details of the preparation and the properties of surfactants, reference is made to Römpp Lexikon Lacke und Druckfarben, 1998 Georg Thieme Verlag Steuttgart, pages 557 to 558, “Tenside”, and Thieme Rompp Online, 2016, Version 3.66, “Amphotenside”, “Biosurfactants”, “Bolaform-Tensides”, “Cotenside”, “Eiweilltenside”, “Fluortenside”, “Gemini-Tenside”, “Aniontenside”, “Kationtenside”, “nich-ionische Tenside”, “Perfluortenside”, “Polymertenside”, “Silicium-Tenside” and “Triton-Tenside”; Dorothea Anna Barbara Strobel, “Schaumbildungseigenschaften von Milchproteinfraktionen und -hydrolysaten”, Dissertation, Kiel 2007; and Bernd Stefan Aha, “Biologisch abbaubare Tenside aus nachwachsenden Rohstoffen: N-Acylaminosäuren—Synthesen und Tensideigenschaften”, Dissertation, Wuppertal, 1999.

Particularly preferably, the at least one surfactant is selected from the group consisting of decyl-, undecyl-, dodecyl-(lauryl-), tridecyl-, tetradecy-, pentadecyl-, hexadecyl-, hexadecyl-octadecyl-, nonadecyl-, and eicosanylsulfate, -ethersulfate, -phosphate, -sulfonate and -sulfoacetate and their salts, their free acids, their esters, their amides, their halides, and their anhydrides.

Most preferably, technical lauryl sulfate is used.

The cations necessary for the salt formation can be organic and inorganic cations. Preferably, the inorganic cations are selected from the group consisting of sodium, potassium and ammonium ions. Preferably, the organic cations are selected from the group consisting of
alkyl and cycloalkyl ammonium, dialkyl and dicycloalkyl ammonium, alkylcycloalkyl ammonium, trialkyl and tricycloalkyl ammonium, dialkylcycloalkyl ammonium, dicycloalkylalkyl ammonium,
trialkyl sulfonium, tricycloalkyl sulfonium, alkyl dicycloalkyl sulfonium and dialkylcycloalkyl sulfonium,
tetraalkyl phosphonium, trialkylcycloalkyl phosphonium, dialkyldicycloalkyl phosphonium, alkyltricycloalkyl phosphonium and
heterocyclic ammonium ions, sulfonium ions and phosphonium ions,

more preferably, methyl ammonium, ethyl ammonium, dimethyl ammonium, diethyl ammonium, trimethyl ammonium, triethyl ammonium, cyclohexyl ammonium, diethylene diammonium, tetramethylene immonium and pentamethylene immonium.

Most preferably, sodium ions are used.

The content of the at least one surfactant can vary widely and, therefore, can be excellently matched with the relevant requirements, in particular with the requirements, which are demanded from the application-technological properties of the porous, mineral lightweight construction materials, in particular porous concrete, prepared from the dispersions of the invention. Preferably, 0.001 to 3% by weight, more preferably 0.01 to 2% by weight and most preferably 0.1 to 1.5% by weight, each based on the dry mass of a given dispersion of the invention are, used.

An additional essential component of the chemical precursor is at least one kind of natural and modified natural homoglycanes selected from the group consisting of potato starch, rice starch, cornstarch and wheat starch and off cooked and/or raw shredded pieces of grains, potatoes and rice. Most preferably, cornstarch is used.

The modified natural starches can be modified acyl groups, in particular, formyl groups, acetyl groups, propionyl groups, butyryl groups, valeryl groups and/or benzoyl groups, acid groups, in particular, sulfate groups, sulfonate groups, phosphate groups and/or phosphonate groups, C1-C10-alkyl groups, in particular, methyl groups and/or ethyl groups and/or C5-C10-cycloalkyl groups, in particular, cyclopentyl groups and/or cyclohexyl groups.

The content of the natural and modified natural starches is from 0.01 to <10% by weight, preferably 0.05 to 4% by weight, more preferably 0.1 to 3% by weight and most preferably 0.15 to 2% by weight, each based on the dry mass of a given dispersion of the invention.

It is essential for the dispersions of the invention that they contain water of a water hardness >3.2 mmol/L, preferably >4 mmol/L and most preferably >4.5 mmol/L, i.e. hard to very hard water.

The water hardness essential for the invention can be present from the start or can be adjusted by adding alkaline earth carbonates.

The water content can vary widely and, therefore, can be excellently adjusted to the requirements, in particular to the requirements which are demanded from the application-technological properties of the porous, mineral lightweight construction materials of the invention, in particular porous concrete, prepared from the dispersions of the invention. Preferably, 5 to 50% by weight, more preferably 10 to 50% by weight and, in particular, 20 to 50% by weight, each based on the complete weight of a dispersion of the invention, are used.

Furthermore, the dispersions of the invention can contain at least one additive selected from the group consisting of synthetic and modified natural polysaccharides, other natural polysaccharides, casein, curd, curd cheese, whey, sourmilk curd, rennet curd, buttermilk curd, kefir lumps, lactic acid, polylactides, gluten, hydrophobines, siloxanes, superliqifiers, water reducing agents, rheological additives, nano, micro and macro fibers, nano and microparticles, radicals, radical initiators, milled bamboo, hydrolyzed bamboo, minerally encapsulated wood chips, lignins and polysaccharides, layered silicates, brick earth, clay, chalk, aerogels, encapsulated aerogels, organically modified aerogels such as those described in the European patent EP 0 948 359 B1, micro silica, silica gels, superabsorbers, polyoxometalates, biocides, pharmaceuticals, dyestuffs, color pigments, white pigments, fluorescent pigments and phosphorescent pigments (phosphors), synthetic polymers, biopolymers, metals, carbon allotropes, with cement and/or water ponded coals, organic and inorganic acids and bases, oxides, oxide catalyst, standard sand, organic and inorganic salts, organic and inorganic foamed materials, fire retardants, anti-scorchers, zeolites, precursors for organically modified ceramic materials, processed ceramic materials, dendritic polymers, liquid crystalline polymers, foaming agents, air-entraining agents, microscalr and macroscale fillers, infusorial earth, fly ash, water glass, milled glass, foamed glass, pumice stone, tuff, lava foam, perlite, vermiculite, latent heat reservoirs, coffee grounds, quick binders, fast cement, cement activators, milled porous concrete, milled porous geopolymers and self-healing agents.

With these additives, the application-technological properties of the dispersions of the invention, and of the porous, mineral lightweight construction materials of the invention, in particular of porous concrete, can be varied in an advantageous, exceedingly wide manner so that completely new applications are realizable.

Some of the aforementioned additives are described below in more detail.

The dispersions of the invention can contain polysaccharides, which differ from the aforementioned starches. Preferably, such additives are synthetic, natural and modified synthetic homoglycanes, heteroglycanes and polyaminosaccharides, which may contain the aforementioned modifying groups.

Examples of suitable homoglycanes are amylose amylopectin, cellulose, chitin, alpha- and beta-glucane and sinistrin.

Examples of suitable heteroglycanes are heparin, fondaparinux and glucosaminoglycanes such as hyaluronic acid.

An example of a suitable polyaminosaccharide is chitosan.

Synthetic polysaccharides are described, for example, by Ursula Kraska and Fritz Micheel in Carbohydrate Research, volume 40, 1976, pages 195-199, or by Fritz Micheel, August Bockmann and Walter Meckstroth, in Macromolecular Chemistry and Physics, volume 48, pages 1-16, 1961.

It is advantages for the dispersions of the invention when they contain so-called superplasticizers, superliqifiers or water reducing agents. Examples of superliqifiers are comb polymers with polyethylene glycol sidechains, sulfonated melamine resins (Rosanil™ F15 of RcF Chemie und Faser GmbH), polynaphthalene sulfonic acid (Rosanil™ BV 71-31 of RcF Chemie und Faser GmbH), alkylsulfonated polysaccharides, lignin sulfate and polycarboxylate ethers as described in the German unexamined laid-open patent application DE 10 2007 045 230 A1 or the European patent application EP 2 774 899 A1. The superliqifiers possess the advantageous effect, namely that they reduce significantly the amount of water necessary for fluidizing a certain amount of cement, cement/geopolymer-mixture or cement/fine sand-mixture, so that the dispersions of the invention remain a longer time and that pourable, formable and pumpable and that a shorter drying time is needed for the hardening.

If used, the content of the dispersions of the invention of superliqifiers can be widely varied and, therefore, can be matched excellently with the requirements of the dispersions of the invention, and with the process II of the invention. Preferably, 0.001 to 3% by weight, more preferably 0.01 to 3% by weight and most preferably 0.05 to 3% by weight, each based on the dry mass of a given dispersion of the invention, are used.

The dispersions of the invention can contain magnetic and/or magnetizable micro and/or nanoparticles. They can be paramagnetic, in particular, superparamagnetic, ferromagnetic, anti-ferromagnetic or ferrimagnetic micro- and/or nanoparticles. In particular, superparamagnetic nanoparticles are used.

In the context of the present invention, microparticles are particles having an average particle size in the range of from 1 to <1000 μm.

In the context of the present invention, nanoparticles are particles having an average particle size in the range of <1000 μm.

Examples of suitable materials for the preparation of such magnetic and/or magnetizable microparticles and/or nanoparticles are
iron, cobalt, nickel and allies of iron with at least one metal selected from the group consisting of ruthenium, osmium, cobalt, rhodium, iridium, nickel, palladium, platinum, copper, silver, gold, zinc, cadmium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, niobium, tantalum, chromium, molybdenum, tungsten, manganese, rhenium, aluminum, gallium, indium, thallium, germanium, tin, lead, antimony and bismuth; examples of suitable metal alloys are magnetically soft metal alloys such as Permalloy™ on the basis of nickel and iron, nickel-iron-zinc alloys or senpowderon the basis of aluminum, silicon and iron; RE_{1-yLay})Fe_{100-v-w-x-z}Co_{w}M_{z}Bₓ, wherein RE designates a rare earth metal selected from the group consisting of cerium, praseodymium, neodymium, samarium, europium, gadolinium, terbium, dysprosium, holmium, erbium, thulium, ytterbium and lutetium and M designates a metal selected from the group consisting of titanium, zirconium, hafnium, vanadium, niobium, tantalum, chromium, molybdenum and tungsten and v=5-15, w≥5, x=9-30, y=0.05-0.5 und z=0.1-5; the aforementioned metals and metal alloys can additionally contain at least one metal and/or nonmetal which is or are selected from the group consisting of lithium, sodium, potassium, rubidium, cesium, beryllium, magnesium, calcium, strontium, barium, boron, carbon, silicon, nitrogen, phosphorus, arsenic, oxygen, sulfur, selenium, tellurium, fluorine, chlorine, bromine and iodine in nonstoichiometric amounts. A particularly well-suited material of this kind is NdFeB; as well as
metal oxides, garnets, spinel and ferrites; examples of particularly suitable materials of this kind are Fe₃O₄, CoFe₂O₄, NiFe₂O₄, MnFe₂O₄, SrFe₂O₄, BaFe₂O₄, CuFe₂O₄, Y₃Fe₅O₁₂, CrO₂, MnO, Mn₃O₄, Mn₂O, FeO, Fe₂O₃, NiO, Cr₂O₃, CoO, Co₃O₄, BaFe₁₂O₁₉, (Bi, La,Tb)(Fe,Mn,DyPr)O₃, Ba₃Co₂Fe₂₄O₄₁, Y₃Fe₃O₁₂, NiZnFe₂O₄, Cu_{0.2}Mg_{0.4}Zn_{0.4}Fe₂O₄, Fe₃O₄(Cu,Ni,Zn)Fe₂O₄, TbMn₂O₃, PbNi_{1/3}Nb_{2,3}TiO₃—CuNiZn, BaTiO₃—NiZnFe₂O₄, doped BaTiO₃, doped SrTiO₃, (Ba,Sr)TiO₃, Pb(Zr,Ti)O₃, SrBi₂Ta₂O₉, PbNi_{1/3}Nb_{2,3}TiO₃—PbTio₃, PbMg_{1/3}Nb_{2,3}TiO₃—PbTiO₃, lanthanum-modified und lanthanum-strontium-modified Pb(Zr,Ti)O₃, Pb(ZrₓTi₁₋ₓ)O₃, wherein x ≥1, PbHfO₃, PbZrO₃, Pb(Zr,Ti)O₃, PbLa(Zr,Sn,Ti)O₃, PbNb(ZrSnTi)O₃, Pb₁₋ₓLax(Zr_{y}Ti_{1-y})_{(1-x)/4}O₃, wherein x ≥1 und y ≥1, LuMnO₃, NaNbO₃, (K,Na)(Nb,Ta)O₃, KNbO₃, BaZrO₃, Na_{0.25}K_{0.25}Bi_{0.5}TiO₃, Ag(Ta,Nb)O₃ or Na_{0.5}Bi_{0.5}TiO₃—K_{0.5}Bi_{0.5}TiO₃—BaTiO₃.

The magnetic and/or magnetizable microparticles and/or nanoparticles can have the most diverse morphologies and geometrical shapes so that they can be excellently matched with the other components of the dispersions of the invention and the porous, mineral lightweight materials prepared therefrom.

Thus, they can be compact and they can have at least one lacuna and/or a core-shell-structure, wherein the core in the shell can be composed of different materials. They can also have different geometrical shapes such as spheres, ellipsoids, cubes, cuboids, pyramids, cylinders, rhombi, dodecahedrons, truncated dodecahedrons, icosahedrons, truncated icosahedrons, dumbbells, tori, platelets or needles with circular, oval, elliptic, square, triangular, quadrangular, pentagonal, hexagonal, heptagonal, octagonal or star-shaped (with 3, 4, 5 or more spikes). Optionally, where applicable, the edges and corners can be rounded. Two or more microparticles and/or nanoparticles of different morphologies and/or geometrical shapes can aggregate. For example, spherical microparticles and/or nanoparticles can have spiky outgrows in the shape of cones. Or two or three cylindrical microparticles and/or nanoparticles can aggregate so that they form a T-shaped or Y-shaped particle. Furthermore, the surface can have indentations so that the microparticles and/or nanoparticles can have strawberry, raspberry or blackberry shaped morphologies. Last but not least, the dumbbells, tori, needles or platelets can be bent in at least one spatial direction.

The diameter of the magnetic and/or magnetizable microparticles and/or nanoparticles can vary very widely and, therefore, can be excellently matched with the other components of the dispersions of the invention and of the porous, mineral lightweight construction materials prepared therefrom.

In the context of the present invention, the diameter of magnetic and/or magnetizable microparticles and/or nanoparticles, having no spherical shape, equals the longest distance laid through the respective microparticles and/or nanoparticles.

Preferably, the diameter is of from 1 to <1000 nm, more preferably of from 1.5 to 750 nm, even more preferably of from 2 to 500 nm, especially preferably o from of 2.5 to 100 nm, and particularly preferably of from 3 to 15 nm.

Likewise, the average particle size, measured by way of transmission electron microscopy (TEM), scanning electron microscopy (SEM), scanning transmission electron microscopy (STEM), scanning force microscopy (SFM) or scanning tunneling microscopy (STM), can also vary very widey and, therefore, can be matched excellently with the other components of the solid, magnetic and/or magnetizable, polymeric nanocomposites used in accordance of the invention and their respective intended purposes.

Preferably, the average particle size is of from 1 to <1000 nm, more preferably of from 1.5 to 750 nm, even more preferably of from 2 to 500 nm, especially preferably of from 2.5 to 100 nm and particularly preferably of from 3 to 50 nm.

The diameter of the magnetic and/or magnetizable microparticles can also vary very widely and, therefore, can be matched excellently with the other components of the dispersions of the invention and the porous, lightweight construction materials prepared therefrom.

The magnetic and/or magnetizable microparticles and/or nanoparticles can have a monomodal, bimodal or multimodal particle size distribution. Preferably, the particle size distribution is monomodal.

The monomodal particle size distribution can be comparatively broad. This means that the fraction of particularly fine and particularly coarse microparticles and/or nanoparticles in a given sample is comparatively high. Preferably, the monomodal particle size distribution is comparatively narrow with only a small fraction of particularly fine and particularly coarse microparticles and/or nanoparticles in a given sample because this way, a uniform property profile of the sample can be guaranteed.

The magnetic and/or the magnetizable microparticles and/or nanoparticles can be bonded to diamagnetic, non-magnetizable microparticles and/or nanoparticles, preferably, however, to nanoparticles. The magnetic and/or magnetizable microparticles and/or nanoparticles, and the diamagnetic microparticles and/or nanoparticles can be bonded to each other by covalent and/or ionic bonds, hydrogen bridging bonds, electrostatic attraction and/or Van der Waals forces.

The diamagnetic microparticles and/or nanoparticles can be used as such. The statements set out above equally apply for their size, shape, and particle size distribution.

Examples for suitable materials from which the diamagnetic microparticles and/or nanoparticles can be prepared, are in particular
oxides from the group consisting of scandium oxide, yttrium oxide, titanium dioxide, zirconium dioxide, yttrium-stabilized zirconium dioxide, hafnium dioxide, vanadium oxides, niobium oxide, tantalum oxide, manganese oxide, iron oxide, chromium oxides, molybdenum oxides, tungsten oxide, zinc oxide, oxides of the lanthanides, in particular lanthanum oxide and cerium oxide, in particular, cerium oxide, oxides of the actinides, magnesium oxide, calcium oxide, strontium oxide, barium oxide, aluminum oxide, zinc-doped aluminum oxide, gallium oxide, indium oxide, silicon dioxide, germanium dioxide, tin oxide, antimony oxide, bismuth oxide, zeolites, spinel, mixed oxides, consisting of at least of two of the above-mentioned oxides such as antimony-tin-oxide, indium-tin-oxide, barium titanate, lead titanate or lead-zirconate-titanate;
phosphates such as hydroxylapatite or calcium phosphate;
polyoxometalates (POM);
sulfides, selenides and tellurides from the group consisting of arsenic, antimony, bismuth, cadmium, zinc, iron, silver, lead and copper sulfide, cadmium selenide, tin selenide, zinc selenide, cadmium telluride and lead telluride;
nitrides such as boron nitride, silicon nitride aluminum nitride, gallium nitride and titanium nitride;
phosphides, arsenides and antimonides from the group consisting of aluminum phosphide, gallium phosphide, indium phosphide, aluminum, arsenide, gallium arsenide, indium arsenide, aluminum antimonide, gallium antimonide and indium antimonide;
intl phases such as Na₄Sn₉, Na₄Pb₉, Na₂Pb₁₀, Na₃[Cu@Sn₉], Na₇[Ge₉CuGe₉] and Na₁₂[Sn₂@Cu₁₂Sn₂₀];
carbon allotropes like fullerenes, graphene, graphite, diamond and functionalized and non-functionalized carbon nanotubes, carbon nanohorns and carbon nanocones;
metal organic framework compounds (MOFs);
carbides such as boron carbide, silicon carbide, tungsten carbide, titanium carbide and cadmium carbide;
borides like zirconium boride; and
silicides like molybdenum silicide.

The magnetic and/or magnetizable and/or diamagnetic microparticles and/or nanoparticles can exist “naked”, which means that their surface is not covered by a shell and/or is not functionalized.

Preferably, the magnetic and/or magnetizable and/or diamagnetic microparticles and/or nanoparticles are covered by a shell and/or they carry at least one functional group. In this case, the material of the shells can carry the functional groups or the functional groups can be directly bonded to the surface of the magnetizable nanoparticles.

The material of the shell and/or the functional groups are selected such that the magnetic and/or magnetizable microparticles and/or nanoparticles are particularly rapidly and homogeneously distributed in the polymer matrix of the solid, magnetic and/or magnetizable, polymeric microparticles and/or nanoparticles and/or such that the physical and/or chemical properties of the magnetic and/or magnetizable microparticles and/or nanoparticles are modified or masked in a particular desired manner.

The shells and/or the functional groups can be bonded to the surface of the magnetic and/or magnetizable microparticles and/or nanoparticles by covalent and/or ionic bonds and/or by electrostatic attraction and/or Van der Waals forces.

The bonding between the surface of the magnetic and/or magnetizable microparticles and/or nanoparticles, and the shell and/or the functional groups can be permanent or reversible, i.e. detachable.

The shells can consist of organic, inorganic and metal organic, polymeric, oligomeric and low molecular materials or of combinations of at least two of these materials.

In the following, examples for suitable functional groups and materials for the shells of the magnetic and/or magnetizable and/or diamagnetic microparticles and/or nanoparticles are cited. The skilled artisan can select the groups and materials which are particularly suited for an individual case on the basis of the property profiles known to him.

It must be emphasized that the functional groups and materials described below cannot only be used as shells for the nanoparticles and/or microparticles but also as additives.

Customary and Known Functional Groups:

Fluorine, chlorine, bromine and iodine atoms; hydroxyl, thiol, ether, thioether, amino, peroxide, aldehyde, acetal, carboxyl, peroxycarboxyl, ester, amide, hydrazide and urethane groups; imide, hydrazone, hydroxime, amide and hydroxamic acid groups; groups derived from formamidine, formamidoxime, formhydrazine, formhydroxideoxime, formamidrazone, formhydrazidine, formhydrazideoxime, formamidrazone, formoxamidine, formhydroxamoxime, and formoxamidrazone; nitrile, isocyanate, isothiocyanate, isonitril, lactide, lactone, lactam, oxime, nitroso, nitro, azo, azoxy, hydrazine, hydrazone, azine, carbodiimide, azide, azane, sulfene, sulfene amide, sulfonamide, thioaldehyde, thioketone, thioacetal, thiocarbonic acid, sulfonium, sulfur halide, sulfoxide, sulfon, sulfimine, sulfoximin, sultone, sultam, silane, siloxane, phosphane, phosphine oxide, phosphonium, phosphoric acids, phosphorous acid, phosphonic acid, phosphate, phosphinate and phosphinate groups.

Customary and Known Additives:

Examples of suitable rheology additives are known from the laid-open patent specifications WO 94/22968, EP 0 276 501 A1, EP 0 249 201 A1 or WO 97/12945; cross-linked polymeric microparticles as disclosed in EP 0 008 127 A1; inorganic layered silicate like aluminum-magnesium-silicate, sodium-magnesium and sodium-magnesium-fluorine-lithium layered silicate of the montmorillonite type; silicic acid, such as Aerosil; or synthetic polymers with ionic and/or groups having an associative effect such as Pure Thix™ of BYK company, polyvinyl alcohol, poly(meth)acrylamide, poly(meth)acrylic acid, polyvinylpyrrolidone, styrene-maleic acid anhydride copolymers or ethylene-maleic acid anhydride copolymers and their derivatives or hydrophobic modified ethoxylated urethanes or polyacrylates.

Examples for suitable organic modified ceramic materials are hydrolyzable metal organic compounds, in particular from silicon and aluminum.

Additional examples for additives are dyestuffs, color pigments, white pigments, fluorescent pigments and phosphorescent pigments (phosphors).

Examples for polymers and oligomers with functional groups are poly (trimethylammoniumethylacrlylate), polyacrylamide, poly(d,l-lactid-co-ethylenglykol), Pluronic®, Tetronic®, polyvinylalkohol (PVA), polyvinylpyrrolidone (PVP), poly(alkylcyanoacrylate), poly(lactic acid), poly(epsilon-caprolactone), polyethylenglykol (PG), poly(oxyethylene-co-propene)bisphosphonate, poly(acrylic acid), poly(methacrylic acid), hyaluronic acid, algininic acid, pectinic acid, poly ethylenimine), poly(vinylpyridine), polyisobutene, poly(styrenesulfonic acid), poly(glycidylmethacrylate), poly(methacryloyloxyethyltrimethylammoniumchlorid) (MATAC), poly(l-lysin) and poly(3-(trimethoxysilyl)propylmethacrylate-r-PEG-methylethermethacrylat), proteins like treptavidin, trypsin, albumin, immunoglobulin, oligo-und polynucleotides like DNA and RNA, peptides like arginylglycylasparginic acid (RGD), AGKGTPSLETTP peptide (A54), HSYHSHSLLRMF peptid (C10) and gluthathione, enzymes like glucoseoxidase, dendrimers like polypropyleneimine tetrahexacontaamine dendrimer generation 5 (PPI G5), poly(amidoamine) (PAMAM) und guanidine dendrimers, phosphonic acid and dithiopyridine functionalized polystyrenes, functionalized polyethylenglykols (PEG: degree of polymerization, 4 to 10 in particular, 5) such as Peg(5)-nitroDOPA, -nitrodopamine, -mimosine,-hydroxydopamine, -hydroxypyridine,-hydroxypyrone und-carboxyl.

Examples for biopolymers are proteoglycans, wherein the polysaccharide fraction outweighs the protein fraction. Additional examples of biopolymers are globulins, elastin, nucleic proteins, histones, keratin, chromoproteins, protamines, fibrinogens, phosphoproteins, prolamines, myosin, lipoproteins and hydrophobines.

In particular, hydrophobines can be advantageously used for rendering the surface of the porous, mineral lightweight construction materials prepared from the dispersions of the invention hydrophobic in accordance with the process II of the invention.

Examples for pharmaceuticals are cytostatic drugs like Cyclophosphamide, Trofosfamide, Ifosfamide, Chlorambucil, Melphalane, Carmustine, Lomustine, Semustine, Busulfane, Cisplatinum, Carboplatinum, Methotrexate, %-Fluoruracil: Cytarbine, Mercapturine, Thioguanine, Vinblastine, Vincristine, Etoposid, Dactinomycine, Daunarubicine, Doxorubicine, Bleomycine, Mitomycine, Mitoxantrone, Diethylstilboestrol, Drostanolone, Testolactone, Tamoxifene, Aminogluthedimide, Busereline, Gosereline, Leuproreline, Triptoreline, hydroxyurea and Procarbacine.

Examples for biocides are
akarizides against mites,
agizides against algae,
bakterizides und bacteriostats against bacteria and bacteria films,
fungizides against fungi,
insektizides against insects,
mikrobiozidal finishes against germs,
molluskizides against snails,
nematizides against nematodes and
viruzides against viruses.

Examples of known biozides are 10,10′-oxybisphenoxoarsin (OBPA), octylisothiazolinone (OIT), dichlorctylisothiazolinone (DCOIT), butylbenzisothiazolinone (BBIT), iodocarb (3-iodo-2-propinylbutylcarbamate), zinc-pyrithione (zinc salt of Pyridine-2-thiol-1-oxide), Trichlosane (polychlorinated phenoxyphenols), silver ions and silver, in particular as silver nanoparticles.

Examples for fungicides are DMI-fungizides, Qol-fungizides, Dithiocarbamate, copper and sulfur, MBC-fungizides, benzimidazole and thiophanate, chloronitrile, dicarboimide, phenylamide, amines, AP-fugizides, MBI-fungizides und SDHI-decoupling agents.

Examples for flame retardants are polybrominated diphenylethers (PentaBDE, OctaBDE, DecaBDE), TBBPA, HBCD, polybrominated biphenyls (PBB), chloroparaffins, Mirex, halogenated flame retardants, melamine, urea, TCEP (tris(chloroethyl)phosphate), TCPP (tris(chloropropyl)phosphate), TDCPP (tris(dichloroisopropyl)phosphate), TPP (triphenylphosphate), TEHP (tris-(2-ethylhexyl)phosphate), TKP (trikresylphosphat), ITP (isopropylated triphenylphosphate) mono-, bis- und tris(isopropylphenyl)phosphate having a varying degree of isopropylation, RDP (resorcinol-bis(diphenylphosphate)), BDP (bisphenol-A-bis(diphenylphosphate)), aluminiumhydroxide [Al(OH)₃], Magnesiumhydroxide [Mg(OH)₂, MDH, “magnesiumdihydrate”], Ammoniumsulfate [(NH₄)₂SO₄] und -phosphate [(NH₄)₃PO₄], red phosphorus, antimonytrioxide (Sb₂O₃), antimonypentoxide (Sb₂O₃), zincborate, hydrated lime [Ca(OH)₂], melaminephosphate and caustic lime.

Examples for polymers are the customary and known thermoplastic or thermoset polymers.

Thermoplastic polymers to be considered are the customary and known linear and/or branched and/or block-like, comb-like and/or statistical polyaddition resins, polycondensation resins and/or (co-)polymers of ethylenically unsaturated monomers.

Examples of suitable (co-)polymers are (meth)acrylate(co-)polymers and/or polystyrene, polyvinyl ester, polyvinyl ether, polyvinyl halides, polyvinyl amides, polyacryl nitriles, polyethylene, polypropylene, polybutylene, polyisoprene and/or their copolymers.

Examples of suitable polyaddition resins or polycondensation resins are polyesters, alkyds, polylactones, polycarbonates, polyethers, proteins, epoxy-amine-adducts, polyurethanes, alkyd resins, polysiloxanes, phenol-formaldehyde-resins, urea-formaldehyde-resins, melamine-formaldehyde-resins, cellulose, polysulfides, polyacetals, polyethyleneoxides, polycaprolactams, polylactones, polylactides, polyimides and/or polyureas.

Generally, unpurified, recycled polymers can be used.

As is known in the art, the thermoset polymers are prepared from multifunctional, low molecular and/or oligomeric compounds by thermally and/or by actinic radiation initiated (co-) polymerization. As functional low molecular and/or oligomeric compounds, reactive thinners, catalysts and initiators can be used.

The above list of thermal plastics and thermoset polymers is not concluding, but shall, in particular illustrate the numerous possibilities available. The skilled artisan can readily select additional suitable polymers on the basis of his general knowledge.

Examples for suitable microscale and macroscale fillers are silicon dioxide, aluminum oxide, zirconium oxide, titanium dioxide, wood scales, separated and dried liquid manure, plastic matting, plastic parts of any shape, filaments, needles and flakes.

Examples for organic and inorganic foam materials are polystyrene foam, polyurethane foam, polypropylene foam and foamed glass.

Examples for suitable nanofibers, microfibers, and macrofibers which can be used for reinforcement are:

Seed Fibers:

such as cotton wool (CO), kapok (KP), poplar fluff, akon, bamboo fibers, Chinese-burn fibers, hemp fibers (HA), jute fibers, kenaf fibers, linen fibers, ops fibers, ramie (RA) and hemp;

Hard Fibers:

Such as pineapple fibers, caroá fibers, henequen fibers, New Zealand flax fibers, Sisal(SI) and cocoa fibers (CC);

Wools and Fine Animal Hairs:

Such as wool from sheep (WO), alpacas, lamas, Vikunjas, guanakos, angora (WA), rabbits, camel hairs (WK), cashmere (WS) and mohair (VM);

Coarse Animal Hairs:

Such as cattle hair, horse hair and goat hair;

Silks:

Like mulberry silk (SE), tussah silks (ST) and mussle silks;

Mineral Fibers:

Like erionite, attapulgite, sepiolithe and wollastonaite;

Cellulose Fibers:

Like viscose (CV), modal (CMD), Lyocell (CLY), cupro (CUP), acetate (CA) and triacetate (CTA);

Rubber Fibers:

From natural or synthetic rubber;

Plant Protein Fibers:

Like soy protein fibers, zeine fibers and other prolamine fibers;

Protein Fibers:

Such as fibers on the basis of casein, albumins, collagen, glycoproteins, globulins, elastin, nucleoproteins, histones, keratin, chromoproteins, protamines, fibrinogen, phosphorproteins, prolamines, myosin, lipoproteins and hydrophobin;

Fibers on the Basis of Starch or Glucose:

Like alginate fibers (ALG) and chitosan fibers;

Polycondensation Fibers:

Like polyesters fibers (PES), polyamides fibers (PA), polyimide fibers (PI), polyamideimide fibers (PAI) and nylon fibers;

Polymerization Fibers:

Like polyacrylonitrile fibers (AN), polyethylene fibers, polypropylene fibers, PMMA-fibers and PVC-fibers;

Polyaddition Fibers:

such as polyurethane fibers (PU);

Inorganic Fibers and Miscellaneous Fibers:

Like aramid fibers, Kevlar fibers, lignin fibers, cellulose fibers, composite fibers, textiles, textile fibers, web fibers, pyrolysis fibers, boron fibers, ceramic fibers, silicic acid fibers, metallic reinforcement fibers such as steel fibers, boron fibers, silicic acid fibers, glass fibers (GF), basalt fibers, carbon fibers, graphene fibers, carbon nanotubes, carbon nanohorns, and carbon nanocones.

The fibers mentioned above can be used as mixed webs, pre-stressed mixed webs and/or pre-stressed mixed webs with textile fibers.

If the aforementioned fibers should be flammable by their nature they could be finished with the above-mentioned flame retardants and/or could be coated with minerals.

Examples of suitable cement accelerators or quick binders are aluminum sulfate or similar soluble sulfates of multivalent cations in combination with calcium aluminate, calcium sulfoaluminate, calcium nitrate, calcium ammonium nitrate and gases like carbon dioxide, carbon monoxide, sulfur dioxide and sulfur trioxide.

Examples of suitable self-healing agents are calcium hydroxide and nanoparticles and microparticles, having a core of calcium hydroxide and a shell of calcium carbonate or glass. A self-healing agent on the basis of bacteria is described by Hendrik Marius Jonkers, “Concrete with self-healing forces”, in Technology Review, November 2016, page 55.

Additional suitable additives are customary and known layered silicates. The elementary composition of the structure of the layered silicate microparticles and/or nanoparticles can also vary very widely. As for example, the classification of the silicates according to the following structures is known:
Neosilicates,
sorosilicates,
cyclosilicates,
inosilicates,
transitional structures between inosilicates and phyllosilicates,
phyllosilicates and
tectosilicates.

Phyllosilicates are silicates, wherein the silicate ions consist of layers of angular bonded SiO₄-tetrahedrons. This layers and/or double layers are not bonded further among each other. The clay minerals which are technically important and common in sedimentary rocks are also phyllosilicates. The layered structure of this minerals determines the shape and the property of these crystals. They are mostly tabular to lamellar with good to perfect cleavability parallel to the layers. The number of positions of the rings from which the silicate layers are assembled, often determines the symmetry and the shape of the crystals. Water molecules, large cations and/or lipids can be intercalated between the layers. The phyllosilicates are often swellable and, due to their cation exchange capacity, they are important for the fertility of soils.

In the following Table 1, the phyllosilicates are listed by way of example and not exclusively. The skilled artisan can readily denominate other particularly suitable phyllosilicates for the respective individual case.

TABLE 1
Elemental Formulas of Suitable Phyllosilicates^{a)}

| No. | Typ | Elemental Formula |
|---|---|---|
| 1 | Martinite | (Na, Ca)₁₁Ca₄(Si, S, B)₁₄B₂O₄₀F₂ · 4(H₂O) |
| 2 | Apophyllite-(NaF) | NaCa₄Si₈O₂₀F · 8H₂O |
| 3 | Apophyllite-(KF) | (K, Na)Ca₄Si₈O₂₀(F, OH) · 8H₂O |
| 4 | Apophyllite-(KOH) | KCa₄Si₈O₂₀(OH, F) · 8H₂O |
| 5 | Cuprorivaite | CaCuSi₄O₁₀ |
| 6 | Wesselsite | (Sr, Ba)Cu[Si₄O₁₀] |
| 7 | Effenbergerite | BaCu[Si₄O₁₀] |
| 8 | Gillespite | BaFe²⁺Si₄O₁₀ |
| 9 | Sanbornite | BaSi₂O₅ |
| 10 | Bigcreekite | BaSi₂O₅ · 4H2O |
| 11 | Davanite | K₂TiSi₆O₁₅ |
| 12 | Dalyite | K₂ZrSi₆O₁₅ |
| 13 | Fenaksite | KNaFe²⁺Si₄O₁₀ |
| 14 | Manaksite | KNaMn²⁺[Si₄O₁₀] |
| 15 | Ershovite | K₃Na₄(Fe, Mn, Ti)₂[Si₈O₂₀(OH)₄] · 4H₂O |
| 16 | Paraershovite | Na₃K₃Fe₂³⁺Si₈O₂₀(OH)₄ · 4H₂O |
| 17 | Natrosilite | Na₂Si₂O₅ |
| 18 | Kanemite | NaSi₂O₅ · 3H₂O |
| 19 | Revdite | Na₁₆Si₁₆O₂₇(OH)₂₆ · 28H₂O |
| 20 | Latiumite | (Ca, K)₄(Si, Al)₅O₁₁(SO₄, CO₃) |
| 21 | Tuscanite | K(Ca, Na)₆(Si, Al)₁₀O₂₂(SO₄, CO₃, (OH)₂) · H₂O |
| 22 | Carletonite | KNa₄Ca₄Si₈O₁₈(CO₃)₄(OH, F) · H₂O |
| 23 | Pyrophyllite | Al₂Si₄O₁₀(OH)₂ |
| 24 | Ferripyrophyllite | Fe³⁺Si₂O₅(OH) |
| 25 | Macaulayite | (Fe³⁺, Al)₂₄Si₄O₄₃(OH)₂ |
| 26 | Talk | Mg₃Si₄O₁₀(OH)₂ |
| 27 | Minnesotaite | Fe₃²⁺Si₄O₁₀(OH)₂ |
| 28 | Willemseite | (Ni, Mg)₃Si₄O₁₀(OH)₂ |
| 29 | Pimelite | Ni₃Si₄O₁₀(OH)₂ · 4H₂0 |
| 30 | Kegelite | Pb₄Al₂Si₄O₁₀(SO₄)(CO₃)₂(OH)₄ |
| 31 | Aluminoseladonite | K(Mg, Fe²⁺)Al[(OH)₂\|Si₄O₁₀] |
| 32 | Ferroaluminoseladonite | K(Fe²⁺, Mg)(Al, Fe³⁺)[(OH)₂\|Si₄O₁₀] |
| 33 | Seladonite | K(Mg, Fe²⁺)(Fe³⁺, Al)Si₄O₁₀(OH)₂ |
| 34 | Chromseladonite | KMgCr[(OH)₂\|Si₄O₁₀] |
| 35 | Ferroseladonite | K(Fe²⁺, Mg)(Fe³+, Al)[(OH)₂\|Si₄O₁₀] |
| 36 | Paragonite | NaAl₂(Si₃Al)O₁₀(OH)₂ |
| 37 | Boromuskovite | KAl₂(Si₃B)O₁₀(OH, F)₂ |
| 38 | Muskovite | KAl₂(Si₃Al)O₁₀(OH, F)₂ |
| 39 | Chromphyllite | K(Cr, Al)₂[(OH, F)₂\|AlSi₃O₁₀] |
| 40 | Roscoelithe | K(V, Al, Mg)₂AlSi₃O₁₀(OH)₂ |
| 41 | Genterite | (Ba, Na, K)(Al, Mg)₂[(OH, F)₂\|(Al, Si)Si₂O₁₀] |
| 42 | Tobelite | (NH₄, K)Al₂(Si₃Al)O₁₀(OH)₂ |
| 43 | Nanpingite | CsAl₂(Si, Al)₄O₁₀(OH, F)₂ |
| 44 | Polylithionite | KLi₂AlSi₄O₁₀(F, OH)₂ |
| 45 | Tainiolite | KLiMg₂Si₄O₁₀F₂ |
| 46 | Norrishite | KLiMn₂³⁺Si₄O₁₂ |
| 47 | Shirkoshinite | KNaMg₂[F₂\|Si₄O₁₀] |
| 48 | Montdorite | KMn_{0.5}²⁺Fe_{1.5}²⁺Mg_{0.5}[F₂\|Si₄O₁₀] |
| 49 | Trilithionite | KLi_{1.5}Al_{1.5}[F₂\|AlSi₃O₁₀] |
| 50 | Masutomilite | K(Li, Al, Mn²⁺)₃(Si, Al)₄O₁₀(F, OH)₂ |
| 51 | Aspidolithe-1M | NaMg₃(AlSi₃)O₁₀(OH)₂ |
| 52 | Fluorophlogopite | KMg₃(AlSi₃)O₁₀F₂ |
| 53 | Phlogopite | KMg₃(Si₃Al)O₁₀(F, OH)₂ |
| 54 | Tetraferriphlogopite | KMg₃[(F,OH)₂\|(Al, Fe³⁺)Si₃O₁₀] |
| 55 | Hendricksite | K(Zn, Mn)₃Si₃AlO₁₀(OH)₂ |
| 56 | Shirozulite | K(Mn²⁺, Mg)₃[(OH)₂\|AlSi₃O₁₀] |
| 57 | Fluorannite | KFe₃²⁺[(F, OH)₂\|AlSi₃O₁₀] |
| 58 | Annite | KFe₃²⁺(Si₃Al)O₁₀(OH, F)₂ |
| 59 | Tetraferriannite | KFe₃²⁺(Si₃Fe3+)O₁₀(OH)₂ |
| 60 | Ephesite | NaLiAl₂(Al₂Si₂)O₁₀(OH)₂ |
| 61 | Preiswekite | NaMg₂Al₃Si₂O₁₀(OH)₂ |
| 62 | Eastonite | KMg₂Al[(OH)₂\|Al₂Si₂O₁₀] |
| 63 | Siderophyllite | KFe₂²⁺Al(Al₂Si₂)O₁₀(F, OH)₂ |
| 64 | Anandite | (Ba, K)(Fe²⁺, Mg)₃(Si, Al, Fe)₄O₁₀(S, OH)₂ |
| 65 | Bityite | CaLiAl₂(AlBeSi₂)O₁₀(OH)₂ |
| 66 | Oxykinositalite | (Ba, K)(Mg, Fe²⁺, Ti⁴⁺)₃(Si, Al)₄O₁₀O₂ |
| 67 | Kinoshitalite | (Ba, K)(Mg, Mn, Al)₃Si₂Al₂O₁₀(OH)₂ |
| 68 | Ferrokinoshitalite | Ba(Fe²⁺, Mg)₃[(OH, F)₂\|Al₂Si₂O₁₀] |
| 69 | Margarite | CaAl₂(Al₂Si₂)O₁₀(OH)₂ |
| 70 | Chernykhite | BaV₂(Si₂Al₂)O₁₀(OH)₂ |
| 71 | Clintonite | Ca(Mg, Al)₃(Al₃Si)O₁₀(OH)₂ |
| 72 | Wonesite | (Na, K,)(Mg, Fe, Al)₆(Si, Al)₈O₂₀(OH, F)₄ |
| 73 | Brammallite | (Na, H₃O)(Al, Mg, Fe)₂(Si, Al)₄O₁₀[(OH)₂, H₂O] |
| 74 | Illite | (K, H₃O)Al₂(Si₃Al)O₁₀(H₂O, OH)₂ |
| 75 | Glaukonite | (K, Na)(Fe³⁺, Al, Mg)₂(Si, Al)₄O₁₀(OH)₂ |
| 76 | Arellite | NaCa₂Si₄O₁₀F |
| 77 | Glagolevite | NaMg₆[(OH, O)₈\|AlSi₃O₁₀] · H₂O |
| 78 | Erlianite | Fe₄²⁺Fe₂³⁺Si₆O₁₅(OH)₈ |
| 79 | Bannisterite | (Ca, K, Na)(Mn²⁺, Fe²⁺, Mg, Zn)₁₀(Si, Al)₁₆O₃₈(OH)₈ · nH₂O |
| 80 | Bariumbannisterite | (K, H₃O)(Ba, Ca)(Mn²⁺, Fe²⁺, Mg)₂₁(Si, Al)₃₂O₈₀(O, OH)₁₆ · 4-12 |
| | | H₂O |
| 81 | Lennilenapeite | K₆₋₇(Mg, Mn, Fe²⁺, Fe³⁺, Zn)₄₈(Si, Al)₇₂(O, OH)₂₁₆ · 16H₂O |
| 82 | Stilpnomelane | K(Fe²⁺, Mg, Fe³⁺, Al)₈(Si, Al)₁₂(O, OH)₂₇ · 2H₂O |
| 83 | Franklinphilite | (K, Na)₁₋ₓ(Mn²⁺, Mg, Zn, Fe³⁺)₈(Si, Al)₁₂(O, OH)₃₆ · nH₂O |
| 84 | Parsettensite | (K, Na, CN)_{7.5}(Mn, Mg)₄₉Si₇₂O₁₆₈(OH)₅₀ · nH₂O |
| 85 | Middendorfite | K₃Na₂Mn₅Si₁₂(O, OH)₃₆ · 2H₂O |
| 86 | Eggletonite | (Na, K, Ca)₂(Mn, Fe)₈(Si, Al)₁₂O₂₉(OH)₇ · 11H₂O |
| 87 | Ganophyllite | (K, Na)ₓMn₆²⁺(Si, Al)₁₀O₂₄(OH)₄ · nH₂O {x = 1-2}{n = 7-11} |
| 88 | Tamaite | (Ca, K, Ba, Na)₃₋₄Mn₂₄²⁺[(OH)₁₂\|{(Si, Al)₄(O, OH)₁₀}₁₀] · 21H₂O |
| 89 | Ekmanite | (Fe²⁺, Mg, Mn, Fe³⁺)₃(Si, Al)₄O₁₀(OH)₂ · 2H₂O |
| 90 | Lunijianlaite | Li_{0.7}Al_{6.2}(Si₇AlO₂₀)(OH, O)₁₀ |
| 91 | Saliotite | Na_{0.5}Li_{0.5}Al₃[(OH)₅\|AlSi₃O₁₀] |
| 92 | Kulkeite | Na_{0.35}Mg₈Al(AlSi₇)O₂₀(OH)₁₀ |
| 93 | Aliettite | Ca_{0.2}Mg₆(Si, Al)₈O₂₀(OH)₄ · 4H₂O |
| 94 | Rectorite | (Na, Ca)Al₄(Si, Al)₈O₂₀(OH)₄ · 2H₂O |
| 95 | Tarasovite | (Na, K, H₃O, Ca)₂Al₄[(OH)₂\|(Si, Al)₄O₁₀]₂ · H₂O |
| 96 | Tosudite | Na_{0.5}(Al, Mg)₆(Si, Al)₈O₁₈(OH)₁₂ · 5H₂O |
| 97 | Corrensite | (Ca, Na, K)(Mg, Fe, Al)₉(Si, Al)₈O₂₀(OH)₁₀ · nH₂O |
| 98 | Brinrobertsite | (Na, K, Ca)_{0.3}(Al, Fe, Mg)₄(Si, Al)₈O₂₀(OH)₄ · 3.5H₂O |
| 99 | Montmorillonite | (Na, Ca)_{0.3}(Al, Mg)₂Si₄O₁₀(OH)₂ · nH₂O |
| 100 | Beidellite | (Na, Ca_{0.5})_{0.3}Al₂(Si, Al)₄O₁₀(OH)₂ · 4H₂O |
| 101 | Nontronite | Na_{0.3}Fe₂³⁺(Si, Al)₄O₁₀(OH)₂ · 4H₂O |
| 102 | Volkonskoite | Ca_{0.3}(Cr³⁺, Mg, Fe³⁺)₂(Si, Al)₄O₁₀(OH)₂ · 4H₂O |
| 103 | Swinefordite | (Ca, Na)_{0.3}(Al, Li, Mg)₂(Si, Al)₄O₁₀(OH, F)₂ · 2H₂O |
| 104 | Yakhontovite | (Ca, Na, K)_{0.3}(CuFe²⁺Mg)₂Si₄O₁₀(OH)₂ · 3H₂O |
| 105 | Hectorite | Na_{0.3}(Mg, Li)₃Si₄O₁₀(F, OH)₂ |
| 106 | Saponite | (Ca\|₂, Na)_{0.3}(Mg, Fe²⁺)₃(Si, Al)₄O₁₀(OH)₂ · 4H₂O |
| 107 | Ferrosaponite | Ca_{0.3}(Fe²⁺, Mg, Fe³⁺)₃[(OH)₂\|(Si, Al)Si₃O₁₀] · 4H₂O |
| 108 | Spadaite | MgSiO₂(OH)₂ · H₂O |
| 109 | Stevensite | (Ca\|₂)_{0.3}Mg₃Si₄O₁₀(OH)₂ |
| 110 | Sauconite | Na_{0.3}Zn₃(Si, Al)₄O₁₀(OH)₂ · 4H₂O |
| 111 | Zinksilite | Zn₃Si₄O₁₀(OH)₂ · 4H₂O |
| 112 | Vermiculite | Mg_{0.7}(Mg, Fe, Al)₆(Si, Al)₈O₂₀(OH)₄ · 8H₂O |
| 113 | Rilandite | (Cr³⁺, Al)₆SiO₁₁ · 5H₂O |
| 114 | Donbassite | Al_{2.3}[(OH)₈\|AlSi₃O₁₀] |
| 115 | Sudoite | Mg₂Al₃(Si₃Al)O₁₀(OH)₈ |
| 116 | Klinochlor | (Mg, Fe²⁺)₅Al(Si₃Al)O₁₀(OH)₈ |
| 117 | Chamosite | (Fe²⁺, Mg, Fe³⁺)₅Al(Si₃Al)O₁₀(OH, O)₈ |
| 118 | Orthochamosit | (Fe²⁺, Mg, Fe³⁺)₅Al(Si₃Al)O₁₀(OH, O)₈ |
| 119 | Baileychlor | (Zn, Fe²⁺, Al, Mg)₆(Si, Al)₄O₁₀(OH)₈ |
| 120 | Pennantite | Mn₅²⁺Al(Si₃Al)O₁₀(OH)₈ |
| 121 | Nimite | (Ni, Mg, Fe²⁺)₅Al(Si₃Al)O₁₀(OH)₈ |
| 122 | Gonyerite | Mn₅²⁺Fe³⁺(Si₃Fe³⁺O₁₀)(OH)₈ |
| 123 | Cookeite | LiAl₄(Si₃Al)O₁₀(OH)₈ |
| 124 | Borocookeite | Li_{1-1.5}Al_{4-3.5}[(OH, F)₈\|(B, Al)Si₃O₁₀] |
| 125 | Manandonite | Li₂Al₄[(Si₂AlB)O₁₀](OH)₈ |
| 126 | Franklinfurnaceite | Ca₂(Fe³⁺Al)Mn³⁺Mn3²⁺Zn₂Si₂O₁₀(OH)₈ |
| 127 | Kaemmererite (Variation of | Mg₅(Al, Cr)₂Si₃O₁₀(OH)₈ |
| | Klinochlor) | |
| 128 | Niksergievite | (Ba, Ca)₂Al₃[(OH)₆\|CO₃\|(Si, Al)₄O₁₀] · 0.2 H₂O |
| 129 | Surite | Pb₂Ca(Al, Mg)₂(Si, Al)₄O₁₀(OH)₂(CO₃, OH)₃ · 0.5 H₂O |
| 130 | Ferrisurite | (Pb, Ca)₂₋₃(Fe³⁺, Al)₂[(OH, F)_{2.5-3}\|(CO₃)_{1.5-2}\|Si₄O₁₀] · 0.5 H₂O |
| 131 | Kaolinite | Al₂Si₂O₅(OH)₄ |
| 132 | Dickite | Al₂Si₂O₅(OH)₄ |
| 133 | Halloysite-7Å | Al₂Si₂O₅(OH₎₄ |
| 134 | Sturtite | Fe³⁺(Mn²⁺, Ca, Mg)Si₄O₁₀(OH)₃ · 10 H₂O |
| 135 | Allophane | Al₂O₃ · (SiO₂)_{1.3-2} · (H₂O)_{2.5-3} |
| 136 | Imogolithe | Al₂SiO₃(OH)₄ |
| 137 | Odinite | (Fe³⁺, Mg, Al, Fe²⁺, Ti, Mn)_{2.4}(Si_{1.8}Al_{0.2})O₅(OH)₄ |
| 138 | Hisingerite | Fe2³⁺Si₂O₅(OH)₄ · 2H₂O |
| 139 | Neotokite | (Mn, Fe²⁺)SiO₃ · H2O |
| 140 | Chrysotil | Mg₃Si₂O₅(OH)₄ |
| 141 | Klinochrysotil | Mg₃Si₂O₅(OH)₄ |
| 142 | Maufite | (Mg, Ni)Al₄Si₃O₁₃ · 4H₂O |
| 143 | Orthochrysotil | Mg₃Si₂O₅(OH)₄ |
| 144 | Parachrysotil | Mg₃Si₂O₅(OH)₄ |
| 145 | Antigorite | (Mg, Fe²⁺)₃Si₂O₅(OH)₄ |
| 146 | Lizardite | Mg₃Si₂O₅(OH)₄ |
| 147 | Karyopilite | Mn₃²⁺Si₂O₅(OH)₄ |
| 148 | Greenalite | (Fe²⁺, Fe³⁺)₂₋₃Si₂O₅(OH)₄ |
| 149 | Berthierin | (Fe²⁺. Fe³⁺, Al)₃(Si, Al)₂O₅(OH)₄ |
| 150 | Fraipontite | (Zn, Al)₂(Si, Al)₂O₅(OH)₄ |
| 151 | Zinalsite | Zn₇Al₄(SiO₄)₆(OH)₂ · 9H₂O |
| 152 | Dozyite | Mg₇(Al, Fe³⁺, Cr)₂[(OH)₁₂\|Al₂Si₄O₁₅] |
| 153 | Amsite | Mg₂Al(SiAl)O₅(OH)₄ |
| 154 | Kellyite | (Mn²⁺, Mg, Al)₃(Si, Al)₂O₅(OH)₄ |
| 155 | Cronstedtite | Fe₂²⁺Fe³⁺(SiFe³⁺)O₅(OH)₄ |
| 156 | Karpinskite | (Mg, Ni)₂Si₂O₅(OH)₄ |
| 157 | Népouite | (Ni, Mg)₃Si₂O₅(OH)₄ |
| 158 | Pecoraite | Ni₃Si₂O₅(OH)₄ |
| 159 | Brindleyite | (Ni, Mg, Fe²⁺)₂Al(SiAl)O₅(OH)₄ |
| 160 | Carlosturanite | (Mg, Fe²⁺, Ti)₂₁(Si, Al)₁₂O₂₈(OH)₃₄ · H₂O |
| 161 | Pyrosmalite-(Fe) | (Fe²⁺, Mn)₈Si₆O₁₅(Cl, OH)₁₀ |
| 162 | Pyrosmalite-(Mn) | (Mn, Fe²⁺)₃Si₆O₁₅(OH, Cl)₁₀ |
| 163 | Brokenhillite | (Mn, Fe)₈Si₆O₁₅(OH, Cl)₁₀ |
| 164 | Nelenite | (Mn, Fe²⁺)₁₆Si₁₂As₃³⁺O₃₆(OH)₁₇ |
| 165 | Schallerite | (Mn²⁺, Fe²⁺)₁₆Si₁₂As₃³⁺O₃₆(OH)₁₇ |
| 166 | Friedelite | Mn₈²⁺Si₆O₁₅(OH, Cl)₁₀ |
| 167 | Mcgillite | Mn₈²⁺Si₆O₁₅(OH)₈Cl₂ |
| 168 | Bementite | Mn₇Si₆O₁₅(OH)₈ |
| 169 | Varennesite | Na₈(Mn, Fe³⁺, Ti)₂[(OH, Cl)₂\|(Si₂O₅)₅] · 12H₂O |
| 170 | Naujakasite | Na₆(Fe²⁺, Mn)Al₄Si₈O₂₆ |
| 171 | Manganonaujakasite | Na₆(Mn²⁺, Fe²⁺)Al₄[Si₈O₂₆] |
| 172 | Spodiophyllite | (Na, K)₄(Mg, Fe²⁺)₃(Fe³⁺, Al)₂(Si₈O₂₄) |
| 173 | Sazhinite-(Ce) | Na₂CeSi₆O₁₄(OH) · nH₂O |
| 174 | Sazhinite-(La) | Na₃La[Si₆O₁₅] · 2H₂O |
| 175 | Burckhardtite | Pb₂(Fe³⁺Te⁶⁺)[AlSi₃O₈]O₆ |
| 176 | Tuperssuatsiaite | Na₂(Fe³⁺, Mn²⁺)₃Si₈O₂₀(OH)₂ · 4H₂O |
| 177 | Polygorskite | (Mg, Al)₂Si₄O₁₀(OH) · 4H₂O |
| 178 | Yofortierite | Mn₅²⁺Si₈O₂₀(OH)₂ · 7H₂O |
| 179 | Sepiolithe | Mg₄Si₆O₁₅(OH)₂ · 6H₂O |
| 180 | Falcondoite | (Ni, Mg)₄Si₆O₁₅(OH)₂ · 6H₂O |
| 181 | Loughlinite | Na₂Mg₃Si₆O₁₆ · 8H₂O |
| 182 | Kalifersite | (K, Na)₅Fe₇³⁺[(OH)₃\|Si₁₀O₂₅]₂ · 12H₂O |
| 183 | Minehillite | (K, Na)₂₋₃Ca₂₈(Zn₄Al₄Si₄₀)O₁₁₂(OH)₁₆ |
| 184 | Truscottite | (Ca, Mn)₁₄Si₂₄O₅₈(OH)₈ · 2H₂O |
| 185 | Orlymanite | Ca₄Mn₃²⁺Si₈O₂₀(OH)₆ · 2H₂O |
| 186 | Fedorite | (Na, K)₂₋₃(Ca, Na)₇[Si₄O₈(F, Cl, OH)2\|(Si₄O₁₀)₃] · 3.5H₂O |
| 187 | Reyerite | (Na, K)₄Ca₁₄Si₂₂Al₂O₅₈(OH)₈ · 6H₂O |
| 188 | Gyrolithe | NaCa₁₆Si₂₃AlO₆₀(OH)₈ · 14H₂O |
| 189 | Tungusite | Ca₁₄Fe₉²⁺[(OH)₂₂\|(Si₄O₁₀)₆] |
| 190 | Zeophyllite | Ca₄Si₃O₈(OH, F)₄ · 2H₂O |
| 191 | Armstronite | CaZr(Si₆O₁₅) · 3 H2O |
| 192 | Jagoite | Pb₁₈Fe₄³⁺[Si₄(Si, Fe³⁺)₆][Pb₄Si₁₆(Si, Fe)₄]O₈₂Cl₆ |
| 193 | Hyttsjöite | Pb₁₈Ba₂Ca₅Mn₂²⁺Fe₂³⁺[Cl\|(Si₁₅O₄₅)₂] · 6H₂0 |
| 194 | Maricopaite | Ca₂Pb₇(Si₃₆, Al₁₂)(O, OH)₉₉ · n(H₂O, OH) |
| 195 | Cavansite | Ca(VO)Si₄O₁₀ · 4H₂O |
| 196 | Pentagonite | Ca(VO)Si₄O₁₀ · 4H₂O |
| 197 | Weeksite | (K, Ba)₂[(UO₂)₂\|Si₅O₁₃] · 4H₂O |
| 198 | Coutinhoite | Th_{0.5}(UO₂)₂Si₅O₁₃ · 3H₂O |
| 199 | Haiweeite | Ca[(UO₂)₂\|Si₅O₁₂(OH)₂] · 6H₂O |
| 200 | Metahaiweeite | Ca(UO₂)₂Si₆O₁₅ · nH₂O |
| 201 | Monteregianite-(Y) | KNa₂YSi₈O₁₉ · 5H₂O |
| 202 | Mountainite | KNa₂Ca₂[Si₈O₁₉(OH)] · 6H₂O |
| 203 | Rhodesite | KHCa₂Si₈O₁₉ · 5H₂O |
| 204 | Delstrawelithe | K₇Na₃Ca₅Al₂Si₁₄O₃₈F₄Cl₂ |
| 205 | Hydrodelstrawelite | KCa₂AlSi₇O₁₇(OH)₂ · 6H₂O |
| 206 | Macdonaldite | BaCa₄Si₁₆O₃₆(OH)₂ · 10H₂O |
| 207 | Cymrite | Ba(Si, Al)₄(O, OH)₈ · H₂O |
| 208 | Kampfite | Ba₁₂(Si₁₁Al₅)O₃₁(CO₃)₈Cl₅ |
| 209 | Lourenswalsite | (K, Ba)₂(Ti, Mg, Ca, Fe)₄(Si, Al, Fe)₆O₁₄(OH)₁₂ |
| 210 | Tienshanite | (Na, K)₉₋₁₀(Ca, Y)₂Na₆(Mn²⁺, Fe²⁺, Ti⁴⁺, Zn)₆(Ti, Nb) |
| | | [(O, F, OH)₁₁\|B₂O₄\|Si₆O₁₅]6 |
| 211 | Wickenburgite | Pb₃CaA[Si₁₀O₂₇] · 3H₂O |
| 212 | Silhydrite | Si₃O₆ · H₂O |
| 213 | Magadiite | Na₂Si₁₄O₂₉ · 11H₂O |
| 214 | Strätlingite | Ca₂Al[(OH)₆AlSiO₂(OH)₄] · 2.5 H₂O |
| 215 | Vertumnite | Ca₄Al₄Si₄O₆(OH)₂₄ · 3H₂O |
| 216 | Zussmanite | K(Fe²⁺, Mg, Mn)₁₃(Si, Al)₁₈O₄₂(OH)₁₄ |
| 217 | Coombsite | K(Mn²⁺, Fe²⁺, Mg)₁₃[(OH)₇\|(Si, Al)₃O₃\|Si₆O₁₈]₂ |

^{a)}cf. Mineralienatlas, Mineralklasse VIII/H-Schichtsilikate (Phyllosilikate), Strunz 8 Systematik

Particularly preferably, bentonite from the group of montmorillonites ((Na,Ca)_{0.3}(Al,Mg)₂Si₄O₁₀(OH)₂.nH₂O) is used. Bentonite is a mixture of various clay minerals containing as the most important component montmorillonite. For example, sodium-bentonite intercalations water. Thus, it can intercalate a plurality of its own dry weight. Moreover, calcium-bentonite can absorb fats and/or oils. A naturally existing kind of bentonite contains mineral oil.

The phyllosilicate-microparticles or and/or the fluorosilicate-nanoparticles are functionalized, non-functionalized, aggregated, not aggregated, agglomerated, not agglomerated, supported and/or unsupported. As for example, they can be functionalized, agglomerated and supported. However, they can also be non-functionalized and aggregated. For the functionalization, the functional groups and materials described above can be used.

Additional additives are polyoxometalates (POM), which impart the dispersions of the invention and the lightweight construction materials of the invention, in particular the porous concrete, with biocidal and oxygen-activating properties.

The POM can be prepared by customary and known wet chemical processes. However, it is also possible to dissolve the POM in water and to spray the resulting solution against a warm stream of air. Moreover, it is possible, to boil down the solution in the vacuum, whereby it is irradiated with IR-radiation.

When the POM are on hand as microparticles and/or nanoparticles, they can be functionalized, non-functionalized, aggregated, not aggregated, agglomerated, not agglomerated, supported and/or unsupported. As for example, they can be functionalized, agglomerated and supported. However, they can also be aggregated. For the functionalization, the functional groups and materials described above can be used.

The elemental compositions and the structures of the POM can vary very widely.

As for example, the classification of the POM according to the following structures is known:
The Lindquist-Hexamolybdatanion, Mo₆O₁₉²⁻,
the Decavanadatanion, V₁₀O₂₈⁶⁻,
the Paratungstatanion B, H₂W₁₂O₄₂¹⁰⁻,
Mo₃₆-Polymolybdate, Mo₃₆O₁₁₂(H₂O)⁸⁻,
the Strandberg-structure, HP₂Mo₅O₂₃⁴⁻,
the Keggin-structure, XM₁₂O₄₀ⁿ⁻,
the Dawson-structure, X₂M₁₈O₆₂ⁿ⁻,
the Anderson-structure, XM₆O₂₄ⁿ⁻,
the Allman-Waugh-structure, X₁₂M₁₈O₃₂ⁿ⁻,
the Weakley-Yamase-structure, XM₁₀O₃₆ⁿ⁻, und
the Dexter-Silverton-structure, XM₁₂O₄₂ⁿ⁻.

The exponent in is an integer of from 3 to 20 and designates the valency of the anion, which varies in dependency of the variables X and M.

The formulas I to XII can serve as another classification principle for the POM:

(BW₁₂O₄₀)⁵⁻ (I),

(W₁₀O₃₂)⁴⁻ (II),

(P₂W₁₈O₆₂)⁶⁻ (III),

(PW₁₁O₃₉)⁷⁻ (IV),

(SiW₁₁O₃₉)⁸⁻ (V),

(HSiW₉O₃₄)⁹⁻ (VI),

(HPW₉O₃₄)⁸⁻ (VII),

(TM)₄(PW₉O₃₄)^{t-} (VIII)

(TM)₄(P₂W₁₅O₅₆)₂^{t-} (IX),

(NaP₅W₃₀O₁₁₀)¹⁴⁻ (X),

(TM)₃(PW₉O₃₄)₂¹²⁻ (XI) und

(P₂W₁₈O₆)⁶⁻ (XII).

In the formula I bis XII™ designates divalent or trivalent transition metal ions such as Mn²⁺, Fe²⁺, Fe³⁺, Co²⁺, Co³⁺, Ni^{2+,} Cu²⁺ und Zn²⁺. The exponent t is an integer designating the valency of the anions, which varies in dependency of the variable TM.

Moreover, POM of the general formula XIII can also be considered:

(AₓGa_{y}NbₐO_{b})^{z-} (XIII).

In the formula XIII the variable A stands for phosphorus, silicon or germanium, and the index x designates 0 or an integer of from 1 to 40. The index y is an integer of from 1 to 10, the index a stands for an integer of from 1 to 8 and the index b is an integer of from 15 to 150. The exponent z varies in dependency of the nature and the degree of oxidation of the variable A. The complexes with water and the active fragments of the POM XIII can also be considered.

When the index x equals 0, y is preferably of from 6-a, wherein the index a equals an integer of from 1 to 5, and the index b is 19.

When the variable A is silicon or germanium, the index x equals 2, the index y equals 18, the index a equals 6, and the index b equals 77.

When the variable A is phosphorus, the index x equals 2 or 4, the index y equals 12, 15, 17 or 30, the index a equals 1, 3 or 6, and the index b is 62 or 123.

Preferably, the anions I to XIII are used as salts with cations, which are approved and used for cleaning and personal hygiene and for pharmaceutical applications.

Examples for suitable cations are:
H⁺, Na⁺, K⁺ and NH₄⁺,
mono-, di-, tri- or tetra-(C₁-C₂₀-alkylammonium) such as pentadecyldimethyl-ferrocenylmethylammonium, undecyldimethylferrocenylmethylammonium, hexadecyltrimethylammonium, octadecyltrimethylammonium, didodecyl-dimethylammonium, ditetradecyldimethylammonium, dihexadecyl-dimethylammonium, dioctadecyldimethylammonium, dioctadecylviologen, trioctadecylmethylammonium and tetrabutylammonium,
mono-, di-, tri- or tetra-(C₁-C₂₀-alkanolammonium) such as ethanolammonium diethanolammonium und triethanolammonium,
monocations of natural existing amino acids like histidinium (HISH⁺), argininium (ARGH⁺) or lysinium (LYSH⁺) or oligo-oder polypeptides with one or more protonated basic amino acid residue(s).

[Cf. U.S. Pat. No. 6,020,369, Spalte 3, Zeile 6, bis Spalte 4, Zeile 29)].

Concrete examples of suitable POM can be seen in the Table 2.

TABLE 2
Elemental Formulas of Suitable POMa)

| | | Structural |
|---|---|---|
| No. | Elemental Formula | Family |
| 1 | [(NMP)₂H]₃PW₁₂O₄₀ | |
| 2 | [(DMA)₂H]₃PMo₁₂O₄₀ | |
| 3 | (NH₄)₁₇Na[NaSb₉W₂₁O₈₆] | Inorganic |
| | | Cryptate |
| 4 | a- und b-H₅BW₁₂O₄₀ | ″ |
| 5 | a- and b-H₆ZnW₁₂O₄₀ | ″ |
| 6 | a- and b-H₆P₂W₁₈O₆₂ | ″ |
| 7 | alpha-(NH₄)₆P₂W₁₈O₆₂ | Wells- |
| | | Dawson- |
| | | Structure |
| 8 | K₁₀Cu₄(H₂O)₂(PW₉O₃₄)₂.20H₂O | ″ |
| 9 | K₁₀Cu₄(H₂O)₂(PW₉O₃₄)₂.20H₂O | ″ |
| 10 | Na₇PW₁₁O₃₉ | ″ |
| | Na₇PW₁₁O₃₉.20H₂O + 2 C₆H₅P(O)(OH)₂ | ″ |
| 11 | [(n-Butyl)₄N]₄H₃PW₁₁O₃₉ | ″ |
| 12 | b-Na₈HPW₉O₃₄ | ″ |
| 13 | [(n-Butyl)₄N]₃PMoW₁₁O₃₉ | ″ |
| 14 | a-[(n-Butyl)₄N]₄Mo8O26 | ″ |
| 15 | [(n-Butyl)₄N]₂W₆O₁₉ | ″ |
| 16 | [(n-Butyl)₄N]₂Mo₆O₁₉ | ″ |
| 17 | a-(NH₄)ₙH₍₄₋ₙ₎SiW₁₂O₄₀ | ″ |
| 18 | a-(NH₄)ₙH₍₅₋ₙ₎BW₁₂O₄₀ | ″ |
| 19 | a-K₅BW₁₂O₄₀ | ″ |
| 20 | K₄W₄O₁₀(O₂)₆ | ″ |
| 21 | b-Na₉HSiW₉O₃₄ | ″ |
| 22 | Na₆H₂W₁₂O₄₀ | ″ |
| 23 | (NH₄)₁₄[NaP₅W₃₀O₁₁₀] | Preyssler- |
| | | Structure |
| 24 | a-(NH₄)₅BW₁₂O₄₀ | ″ |
| 25 | a-Na₅BW₁₂O₄₀ | ″ |
| 26 | (NH₄)₄W₁₀O₃₂ | ″ |
| 27 | (Me₄N)₄W₁₀O₃₂ | ″ |
| 28 | (HISH⁺)ₙH₍₅₋ₙ₎BW₁₂O₄₀ | ″ |
| 29 | (LYSH⁺)ₙH₍₅₋ₙ₎BW₁₂O₄₀ | ″ |
| 30 | (ARGH⁺)ₙH₍₅₋ₙ₎BW₁₂O₄₀ | ″ |
| 31 | (HISH⁺)ₙH₍₄₋ₙ₎SiW₁₂O₄₀ | ″ |
| 32 | (LYSH⁺)ₙH₍₄₋ₙ₎SiW₁₂O₄₀ | ″ |
| 34 | (ARGH⁺)ₙH₍₄₋ₙ₎SiW₁₂O₄₀ | ″ |
| 35 | K₁₂[EuP₅W₃₀O₁₁₀].22H₂O^{b)} | ″ |
| 36 | a-K₈SiW₁₁O₃₉ | ″ |
| 37 | K₁₀(H₂W₁₂O₄₂) | ″ |
| 38 | K₁₂Ni₃(II)(PW₉O₃₄)₂.nH₂O | ″ |
| 39 | (NH₄)₁₀Co₄(II)(PW₉O₃₄)₂.nH₂O | ″ |
| 40 | L₁₂Pd₃(II)(PW₉O₃₄)₂.nH₂O | ″ |
| 41 | Na₁₂P₂W₁₅O₅₆.18H₂O | ″ |
| 42 | Na₁₆Cu₄(H₂O)₂(P₂W₁₅O₅₆)₂.nH₂O | Lacunar |
| | | (defect) |
| | | Structure |
| 43 | Na₁₆Zn₄(H₂O)₂(P₂W₁₅O₅₆)₂.nH₂O | ″ |
| 44 | Na₁₆Co₄(H₂O)₂(P₂W₁₅O₅₆)₂.nH₂O | ″ |
| 45 | Na₁₆Nᵢ₄(H₂O)(P₂W₁₅O₅₆)₂.nH₂O | ″ |
| 46 | Na₁₆Mn₄(H₂O)₂(P₂W₁₅O₅₆)₂.nH₂O | Wells- |
| | | Dawson- |
| | | Sandwich- |
| | | Structure |
| 47 | Na₁₆Fe₄(H₂O)₂(P₂W₁₅O₅₆)₂.nH₂O | ″ |
| 48 | K₁₀Zn₄(H₂O)₂(PW₉O₃₄)₂.20H₂O | ″ |
| 49 | K₁₀Ni₄(H₂O)₂(PW₉O₃₄)₂.nH₂O | Keggin- |
| | | Sandwich- |
| | | Structure |
| 50 | K₁₀Mn₄(H₂O)₂(PW₉O₃₄)₂.nH₂O | ″ |
| 51 | K₁₀Fe₄(H₂O)₂(PW₉O₃₄)₂.nH₂O | ″ |
| 52 | K12Cu3(PW9O34)2.nH2O | ″ |
| 53 | K₁₂(CoH₂O)₃(PW₉H₃₄)₂.nH₂O | ″ |
| 54 | K₁₂Zn₃(PN₉O₃₄)₂.15H₂O | ″ |
| 55 | K₁₂Mn₃(PW₉O₃₄)₂.15H₂O | ″ |
| 56 | K₁₂Fe₃(PW₉O₃₄)₂.25H₂O | ″ |
| 57 | (ARGH⁺)₁₀(NH₄)₇Na[NaSb₉W₁₂O₈₆] | ″ |
| 58 | (ARGH⁺)₅HW₁₁O₃₉.17H₂O | ″ |
| 59 | K₇Ti₁₂W₁₀O₄₀ | ″ |
| 60 | [(CH3)4N]7Ti2W10O40 | ″ |
| 61 | Cs₇Ti₁₂W₁₀O₄₀ | ″ |
| 62 | [HISH⁺]₇Ti₂W₁₀O₄₀ | ″ |
| 63 | [LYSH⁺]ₙNa₇₋ₙPTi₂W₁₀O₄₀ | ″ |
| 64 | [ARGH⁺]ₙNa₇₋ₙPTi₂W₁₀O₄₀ | ″ |
| 65 | [n-Butyl₄N⁺]₃H₃C₁₀O₂₈ | ″ |
| 66 | K₇NHb₆O₁₉.13H₂O | ″ |
| 67 | [(CH₃)₄N⁺]₄SiW₁₁O₃₉—O[SiCH₂CH₂C(O)OCH₃]₂ | Organic |
| | | Modified |
| | | Structure |
| 68 | [(CH₃)₄N⁺]₄PW₁₁O₃₉—(SiCH₂CH₂CH₂CN) | ″ |
| 69 | [(CH₃)₄N⁺]₄PW₁₁O₃₉—(SiCH₂CH₂CH₂Cl) | ″ |
| 70 | [(CH₃)₄N⁺]₄PW₁₁O₃₉—(SiCH₂═CH₂) | ″ |
| 71 | Cs₄[SiW110₃₉—(SiCH₂CH₂C(O)OCH₃)₂]₄ | ″ |
| 72 | Cs₄[SiW110₃₉—(SiCH₂CH₂CH₂CN)]₄ | ″ |
| 73 | Cs₄[SiW110₃₉—(SiCH₂CH₂Cl)₂]₄ | ″ |
| 74 | Cs₄[SiW110₃₉—(SiCH₂═CH₂)]₄ | ″ |
| 75 | [(CH₃)₄N⁺]₄SiW₁₁O₃₉—O—(SiCH₂CH₂CH₂Cl)₂ | ″ |
| 76 | [(CH₃)₄N⁺]₄SiW₁₁O₃₉—O(SiCH₂CH₂CH₂CN)₂ | ″ |
| 77 | [(CH₃)₄N⁺]₄SiW₁₁O₃₉—O(SiCH₂═CH₂)2 | ″ |
| 78 | [(CH₃)₄N⁺]₄SiW₁₁O₃₉—OSiC(CH₃)₂ | ″ |
| 79 | [(CH₃)₄N⁺]₄SiW₁₁O₃₉—OSiCH₂CH(CH₃)₃ | ″ |
| 80 | [(CH₃)₄N⁺]₄SiW₁₁O₃₉—O[SiCH₂CH₂C(O)OCH₃]₂ | ″ |
| 81 | K₅Mn(II)PW₁₁O₃₉.nH₂O | With |
| | | Transition |
| | | Metal |
| | | Substituted |
| | | Structure |
| 82 | K₈Mn(II)P₂W₁₇O₆₁.nH₂O | ″ |
| 83 | K₈Mn(II)SiW₁₁O₃₉.nH₂O | ″ |
| 84 | K₅PW₁₁O₃₉[Si(CH₃)₂].nH₂O | ″ |
| 85 | K₃PW₁₁O₄₁(PC₆H₅)₂.nH₂O | ″ |
| 86 | Na₃-PW₁₁O₄₁(PC₆H₅)₂.nH₂O | ″ |
| 87 | K₅PTiW₁₁O₄₀ | ″ |
| 88 | Cs₅PTiW₁₁O₃₉ | ″ |
| 89 | K₆SiW₁₁O₃₉[Si(CH₃)₂].nH₂O | ″ |
| 90 | KSiW₁₁O₃₉[Si(C₆H₅)(tert.-C₄H₉)].nH₂O | ″ |
| 91 | K₆SiW₁₁O₃₉[Si(C₆H₅)₂].nH₂O | ″ |
| 92 | K₇SiW₉Nb₃O₄₀.nH₂O | ″ |
| 93 | Cs₇SiW₉Nb₃O₄₀.nH₂O | ″ |
| 94 | Cs₈Si₂W₁₈Nb₆O₇₇.nH₂O | ″ |
| 95 | [(CH₃)₃NH⁺]₈SiW₉Sb₃O₄₀.nH₂O | Substituted |
| | | Keggin- |
| | | Structure |
| 96 | (CN₃H₆)₇SiW₉Nb₃O₄₀.nH₂O | ″ |
| 97 | (CN₃H₆)₈Si₂W₁₈Nb₆O₇₇.nH₂O | ″ |
| 98 | Rb₇SiW₉Nb₃O₄₀.nH₂O | ″ |
| 99 | Rb₈Si₂W₁₈Nb₆O₇₇.nH₂O | ″ |
| 100 | K₈Si₂W₁₈Nb₆O₇₇.nH₂O | ″ |
| 101 | K₆P₂Mo₁₈O₆₂.nH₂O | ″ |
| 102 | (C₆H₅N)₈HSi₂W₁₈Nb₆O₇₇.nH₂O | ″ |
| 103 | (C₆H₅N)₈SiW₉Nb₃O₄₀.nH₂O | ″ |
| 104 | (ARGH⁺)₈SiW₁₈Nb₆O₇₇.18H₂O | ″ |
| 105 | (LYSH⁺)₇KSiW₁₈Hb₆O₇₇.18H₂O | ″ |
| 106 | (HISH⁺)₆K₂SiW₁₈Nb₆O₇₇.18H₂O | ″ |
| 107 | [(CH₃)₄N⁺]₄SiW₁₁O₃₉—O(SiCH₂CH₃)₂ | ″ |
| 108 | [(CH₃)₄N⁺]₄SiW₁₁O₃₉—O(SiCH₃)₂ | ″ |
| 109 | [(CH₃)₄N⁺]₄SiW₁₁O₃₉—O(SiC₁₆H₃₃)₂ | ″ |
| 110 | Li₉P₂V₃(CH₃)₃W₁₂O₆₂ | ″ |
| 111 | Li₇HSi₂W₁₈Nb₆O₇₇ | ″ |
| 112 | Cs₉P₂V₃CH₃W₁₂O₆₂ | ″ |
| 113 | Cs₁₂P₂V₃W₁₂O₆₂ | ″ |
| 114 | K₄H₂PV₄W₈O₄₀ | ″ |
| 115 | Na₁₂P₄W₁₄O₅₈ | ″ |
| 116 | Na₁₄H₆P₆W₁₈O₇₉ | ″ |
| 117 | a-K₅(NbO₂)SiW₁₁O₃₉ | ″ |
| 118 | aO₂)SiW₁₁O₃₉ | ″ |
| 119 | [(CH₃)₃NH⁺)₅NbSiW₁₁O₄₀ | ″ |
| 120 | [(CH₃)₃NH⁺]₅TaSiW₁₁O₄₀ | ″ |
| 121 | K₆Nb₃PW₉O₄₀ | Peroxo- |
| | | Keggin- |
| | | Structure |
| 122 | [(CH₃)₃NH⁺]₅(NbO₂)SiW₁₁O₃₉ | ″ |
| 123 | [(CH₃)₃NH⁺]₅(TaO₂)SiW₁₁O₃₉ | ″ |
| 124 | K₄(NbO₂)PW₁₁O₃₉ | ″ |
| 125 | K₇(NbO₂)P₂W₁₁O₆₁ | ″ |
| 126 | [(CH₃H₃NH⁺]₇(NbO₂)₃SiW₉O₃₇ | ″ |
| 127 | Cs₇(NbO₂)₃SiW₈O₃₇ | ″ |
| 128 | K₆(NbO₂)₃PW₉O₃₇ | ″ |
| 129 | Na₁₀(H₂W₁₂O₄₂) | ″ |
| 130 | K₄NbPW₁₁O₄₀ | ″ |
| 131 | [(CH₃)₃NH₊]₄NbPW₁₁O₄₀ | ″ |
| 132 | K₅NbSiW₁₁O₄₀ | ″ |
| 133 | K₅TaSiW₁₁O₄₀ | ″ |
| 134 | K₇NbP₂W₁₇O₆₂ | Wells- |
| | | Dawson- |
| | | Structure |
| 135 | K₇(TiO₂)₂PW₁₀O₃₈ | ″ |
| 136 | K₇(TaO₂)₃SiW₉O₃₇ | ″ |
| 137 | K₇Ta₃SiW₉O₄₀ | ″ |
| 138 | K₆(TaO₂)₃PW₉O₃₇ | ″ |
| 139 | K₆Ta₃PW₉O₄₀ | ″ |
| 140 | K₈Co₂W₁₁O₃₉ | ″ |
| 141 | H₂[(CH₃)₄N⁺]4(C₂H₅Si)₂CoW₁₁O₄₀ | ″ |
| 142 | H₂[(CH₃)₄N+]₄(iso-C₄H₉Si)₂CoW₁₁O₄₀ | ″ |
| 143 | K₉Nb3P₂W₁₅O₆₂ | ″ |
| 144 | K₉(NbO₂)₃P₂W₁₅O₅₉ | ″ |
| 145 | K₁₂(NbO₂)₆P₂W₁₂O₅₆ | Well- |
| | | Dawson- |
| | | Peroxo- |
| | | structure |
| 146 | K₁₂Nb₆P₂W₁₂O₆₂ | Wells- |
| | | Dawson- |
| | | Structure |
| | | continued |
| 147 | a₂-K₁₀P₂W₁₇O₆₁ | ″ |
| 148 | K₆Fe(III)Nb₃P₂W₁₅O₆₂ | ″ |
| 149 | K₇Zn(II)Nb₃P₂W₁₇O₆₂ | ″ |
| 150 | (NH₄)₆(a-P₂W₁₈O₆₂).nH₂O | ″ |
| 151 | K₁₂[H₂P₂W₁₂O₄₈].24H₂O | ″ |
| 152 | K₂Na₁₅H₅[PtMo₆O₂₄.8H₂O | ″ |
| 153 | K₈[a₂-P₂W₁₇MoO₆₂].nH₂O | ″ |
| 154 | KHP₂V₃W₁₅O₆₂.34H₂O | ″ |
| 155 | K₆[P₂W₁₂Nb₆O₆₂].24H₂O | ″ |
| 156 | Na₆[V₁₀O₂₈].H₂O | ″ |
| 157 | (Gaunidinium)₈H[PV₁₄O₆₂].3H₂O | ″ |
| 158 | K8H[PV14O62] | ″ |
| 159 | Na_{7[}MnV₁₃O₃₈].18H₂O | ″ |
| 160 | K₆[BW₁₁O₃₉Ga(OH)₂].13H₂O | ″ |
| 161 | K₇H[Nb₆O₁₉].13H₂O | ″ |
| 162 | [(CH₃)₄N⁺/Na⁺/K⁺]₄[Nb₂W₄O₁₉] | ″ |
| 163 | [(CH₃)₄N⁺]₉[P₂W₁₅Nb₃O₆₂] | ″ |
| 164 | [(CH₃)₄N⁺]₁₅[HP₄W₃₀Nb₆O₁₂₃].16H₂O | ″ |
| 165 | [Na/K]₆[Nb₄W₂O₁₉] | ″ |
| 166 | [(CH₃)₄N⁺/Na⁺/K⁺]5[_{Nb3W3O19]}.6H₂O | ″ |
| 167 | K₅[CpTiSiW₁₁O₃₉].12H₂O | ″ |
| 169 | b₂-K₈[SiW₁₁O₃₉].14H₂O | ″ |
| 170 | a-K₈[SiW₁₀O₃₈].12H₂O | ″ |
| 171 | Cs₇Na₂[PW₁₀O₃₇].8H₂O | ″ |
| 172 | Cs6[P2W5O23].7,5H2O | ″ |
| 173 | g-Cs₇[PW₁₀O₃₆].7H₂O | ″ |
| 174 | K₅[SiNbW₁₁O₄₀].7H₂O | ″ |
| 175 | K₄[PNbW₁₁O₄₀].12H₂O | ″ |
| 176 | Na₆[Nb₄W₂O₁₉].13H₂O | ″ |
| 177 | K₆[Nb₄W₂O₁₉].7H₂O | ″ |
| 180 | K₄[V₂W₄O₁₉].3,5H₂O | ″ |
| 181 | Na₅[V₃W₃O₁₉].12H₂O | ″ |
| 182 | K₆[PV₃W₉O₄₀].14H₂O | ″ |
| 183 | Na₉[A-b-GeW₉O₃₄].8H₂O | ″ |
| 184 | Na₁₀[A-a-GeW₉O₃₄].9H₂O | ″ |
| 185 | K₇[BV₂W₁₀O₄₀].6H₂O | ″ |
| 186 | Na₅[CH₃Sn(Nb₆O₁₉)].10H₂O | ″ |
| 187 | Na₈[Pt(P(m-SO₃C₆H₅)₃)₃Cl].3H₂O | ″ |
| 188 | [(CH₃)₃NH⁺]₁₀(H)[Si(H)₃W₁₈O₆₈].10H₂O | ″ |
| 189 | K₇[A-a-GeNb₃W₉O₄₀].18H₂O | ″ |
| 190 | K₇[A-b-SiNb₃W₉O₄₀].20H₂O | ″ |
| 191 | [(CH₃)₃NH⁺]9[A-a-HGe₂Nb₆W₁₈O₇₈ | ″ |
| 192 | K₇(H)[A-a-Ge₂Nb₆W₁₈O₇₇].18H₂O | ″ |
| 193 | K₈[A-b-Si₂Nb₆W₁₈O₇₇] | ″ |
| 194 | [(CH₃)₃NH⁺]₈[A-B-Si₂Nb₆W₁₈O₇₇] | ″ |

^{a)}cf. U.S. Pat. No. 6,020,369, TABLE 1, columns 3 to 10;
^{b)}Tierui Zhang, Shaoquinb Liu, Dirk G. Kurth und Charl F. J. Faul, >>Organized Nanostructured Complexes of Polyoxometalates and Surfactants that Exhibit Photoluminescence and Electrochromism, Advanced Functional Materials, 2009, 19, pages 642-652;
n number, in particular an integer of from 1 to 50.

Additional examples of suitable POM are known from the American patent U.S. Pat. No. 7,097,858 B2, column 14, line 56 to column 17, line 19, as well as from TABLE 8a, column 22, line 41 to column 23, line 28, compounds No. 1-53 and TABLE 8b, column 23, line 32 to column 25, line 34, compounds No. 1 to 150.

Especially preferably, H₄[Si(W₃O₁₀)₄].xH₂O (CAS-Nr. 12027-43-9) and H₃[P(W₃O₁₀)₄].xH₂O (CAS-Nr. 12501-23-4) and/or their salts are used.

Furthermore, the dispersions of the invention can contain lecithin.

Moreover, they can contain customary and known superabsorbers from the group consisting of
copolymers of acrylic acid and/or methacrylic acid with alkaline acrylate and/or alkaline methacrylate;
copolymers on the basis of starches and acrylates and/or methacrylates; and
copolymers on the basis of polyacrylamides and alkaline acrylates and/or alkaline methacrylates.

In a preferred embodiment, the dispersions of the invention can contain cellulose nanofibers (CNF), micro-fibrillate cellulose (MFC), nanocrystalline cellulose (CNC), bacterial nanocellulose (BNC) and/or microcrystalline cellulose (MCC), preferably in an amount of from 0.001% by weight to 5% by weight, more preferably of from 0.01% by weight to 2.5% by weight, and particularly preferably of from 0.1% by weight to 1% by weight, each weight percentage being based on the dry mass of a given dispersion.

The nanocellulose participates in the stabilization of the dispersions of the invention. In a further even more preferable embodiment, the dispersions of the invention contain carbon particles, preferably of an average particle size of from 10 nm to 1000 μm, which particles are soaked with cement and/or water glass.

Preferably, the carbon particles are selected from the group consisting of biochar, pyrogenic charcoal, plant charcoal, wood charcoal, sieve residues of wood charcoal, wood ash, activated charcoal, mineral coals, animal coals, animal waste coals, pyrogenic charcoal of diverse degrees of pyrolysis, functionalized coals, pretreated coals, washed coals and extracted coals. In particular, the biochar and/or the pyrogenic charcoal is used. These materials are customary and known and are disclosed, for example, by the German laid-open patent application DE 10 2015 010 041 A1, paragraphs [0055] to [0064].

Preferably, the dispersions of the invention can contain the soaked or aged carbon particles in the amount of from 0.1% by weight to <50% by weight, each based on the complete weight of a given lightweight material.

The soaking or aging are customary and known processes and are described, for example, inSalman, Scholze, Keramik, 7. Auflage, Springer, 2006, pages 593 ff.; Fritz Ullmann, Enzyklopädie der technischen Chemie, Band 17, Urban & Schwarzenberg, Wilhelm Foerst; or H. G. Hirschberg, Handbuch Verfahrenstechnik und Anlagenbau Chemie, Technik, Wirtschaftlichkeit, Springer 2013, page 623.

Volatile organic compounds (VOCs), toxic substances, heavy metals and unpleasantly smelling compounds can be absorbed by the carbon particles and, for example, can be removed from production halls, tanks, transportation vessels, pumps and other handling facilities, which is a particular essential advantage.

Likewise, wood shredding, lignin and/or polysaccharides can be soaked or aged with cement and/or water glass. Apart from that, the additives described above can be used in customary and known amounts provided that nothing else is mentioned.

The additives described above can be packed individually or as a mixture of at least two of such additives, and can be sold as commercial products. In doing so, the packed amounts of additives are each adjusted to the amounts of cement foam or porous concrete to be produced. To this end, tables and data sheets can be prepared, which show the respective amounts.

The dispersions of the invention are preferably prepared in the context of the process of the invention for the preparation of the lightweight construction materials of the invention. In doing so, at least.
at least one kind of cement and/or at least one kind of the zinc phosphate cement or a mixture M of (i) at least one kind of cement and/or at least one kind of zinc phosphate cement and (ii) at least one silicate and/or at least one alumosilicate each having the alkaline or acidic activator for the preparation of a geopolymer and/or at least a geopolymer in a weight ratio (i):(ii)=1000-0.1,
at least one surfactant,
0.01 to <10% by weight, based on the dry mass of the dispersions of the invention, at least one kind of modified and/or non-modified natural homoglycanes selected from the group consisting of potato starch, rice starch, cornstarch and wheat starch and of cooked and/or wrong, shredded pieces of graying, potatoes and rice, and
water of a water hardness larger >3.2 mmol/L

are mixed with each other at atmospheric pressure at the air preferably at a temperature of from 10° C. to 80° C., more preferably of from 15° C. to 70° C. and in particular of from 20° C. to 60° C. in a mixture. Thereafter, the resulting dispersion of the invention is foamed, and the resulting foam is poured and/or pumped and/or applied onto a surface and/or sprayed into molds, cavities, fissures and/or cracks and/or is formed by 3-D printing to shapes and is thereafter dried preferably for one minute to 168 hours (7 days) at the air and at atmospheric pressure, at lowered pressure, by freeze-drying and/or with microwaves. Thereafter, the lightweight construction material of the invention is already safe to walk on.

In doing so, it is advantageous to carry out the drying at 10° C. to 130° C., preferably 15° C. to 120° C. and in particular 20° C. to 100° C., whereby the foam is set and the lightweight building material of the invention is produced. The molds, cavities, fissures and cracks can have diverse shapes and/or structures and/or their walls can consist of diverse materials. Moreover, the materials can be warm, cold, frozen and/or heatable.

After a downtime of 3 days to 4 weeks, the lightweight materials of the invention can be sealed without causing the formation of mold by residual moisture. Examples of suitable sealing methods are coating with plastics, lacquers and varnishes or foils.

The mixing and the foaming can be carried out in the same mixer or in different mixers. During the mixing and foaming, air and/or gas bubbles of the diameter of 1 nm to 10 mm result. The particle size distribution of the bubbles can vary very broadly and can be monomodal, bimodal or multimodal and, therefore, can be adapted excellently to the respective purpose of the light weight building material of the invention. In general, foams with an average diameter of <1000 μm are produced by mixing and foaming with high-speed in the mixtures and/or by using a long mixing time.

In a preferred embodiment of the process described above, the components of the dispersions of the invention are mixed with each other during 1 hour to 10 hours, preferably during 1.5 hours to 7 hours, and in particular during 1.5 hours to 5 hours by gentle stirring. Thereafter, the resulting dispersions of the invention are foamed at the air at atmospheric pressure by intensive stirring, preferably during 5 minutes to 60 minutes, more preferably during 10 minutes to 50 minutes and in particular during 20 minutes to 40 minutes.

In another preferred embodiment, the liquid cement or a mixture M is transported to the site of use without the addition of the surfactant and/or the homoglycanes where the liquid cement or the mixture M is completed by adding the surfactant and/or the homoglycanes and is foamed with intensive stirring.

The mixing ratios of the components of the dispersions of the invention can be varied in an advantageous manner, in order to manufacture the lightweight construction materials of the invention, in particular, the porous concrete, with various advantageous application-technical property profiles.

Preferably, at least one superliqifier is used as the at least one additive because this way significant amounts of water can be saved and the resulting foamed dispersions of the invention remain nevertheless flowable, pumpable, pourable and sprayable for a long time. Preferably, mixers are used, which allow a particular intensive mixing of the components at atmospheric pressure. Examples of suitable mixers are static mixers, in-line-dissolvers, homogenizing nozzles, ultraturrax, rapid stirrers, mills, kneaders, hooks, wire whips and/or ultrasonic sound. The mixers can be combined in a suitable manner with each other in order to achieve an optimal result.

Likewise, the mixing velocities can be varied in an advantageous manner in order to adjust the application-technical property profiles of the porous, open cell or closed cell, hydrophilic or hydrophobic, mineral lightweight construction materials of the invention, in particular, of the porous concrete, in the desired manner.

In doing so, the density and the strength of the porous, mineral lightweight material can be varied by the stirring time, the stirring velocity, the amounts of gas and/or the size of the bubbles.

Moreover,
gases like carbon dioxide, air or nitrogen can be blown in and/or
volatile, inert, non-toxic liquids as butane or pentane and/or
solid blowing agents, containing a carbon dioxide carrier selected from the group consisting of carbonates, hydrogen carbonates and carbamates of the alkaline metals, the alkaline earth metals, aluminum, transition metals and/or ammonium, and at least one acid carrier like sodium aluminum sulfate (DE 10 2009 028 562 A1), and/or nitrocellulose and/or black powder and/or
bubble forming agents like tall resins and balsam resins, lignin sulfonates and salts of carboxylic compounds

can be added before and/or during the foaming.

Furthermore, polymers, as for example, PLA (polylactide) can be worked in. When, for example, lactic acid is added during the preparation and/or the foaming of the dispersions of the invention, a lightweight construction material of the invention containing PLA will result. The addition of lactic acid can be carried out at any time. It can be added during the mixing and/or it is sprayed into the molds, wherein the lightweight construction material of the invention is hardened, and/or it is sprayed onto the surface of the lightweight construction material of the invention. Catalysts can also be added to the dispersions of the invention before, during and/or after the further processing in order to quicken the processes.

In particular, the preferred porous, open cell or closed cell, hydrophilic or hydrophobic, mineral lightweight construction materials of the invention contain, based on each given lightweight construction material,
50% by weight to 99.989% by weight, preferably 60% by weight to 99.989% by weight and, in particular, 70% by weight to 99.989% by weight of at least one kind of cement and/or at least one kind of zinc phosphate cement or a mixture M of (i) at least one kind of cement and/or at least one kind of zinc phosphate cement and (ii) at least one silicate and/or at least one alumosilicate each having at least one alkaline or acidic activator for the preparation of a geopolymer and/or at least one geopolymer having weight ratio (i):(ii)=1000-0.1,
0.001% by weight to 3% by weight of at least one surfactant and
0.01% by weight to <10% by weight of at least one kind of modified and/or non-modified natural homoglycanes selected from the group consisting of potato starch, rice charge, cornstarch, and wheat starch and of cooked and/or raw shredded pieces of grain, potatoes and rice.

The preferred lightweight construction materials of the invention can contain at least one of the additives described above in detail which are selected from the group consisting of synthetic, modified natural polysaccharides, other natural polysaccharides, sugars, superliqifiers, water reducing agents, rheological additives, nano fibers, microfibers and macrofibers, nanoparticles and microparticles, lignin, milk, bamboo, hydrolyzed bamboo, minerally encapsulated bamboo, minerally encapsulated wood chips, phyllosilicates, brick earth, clay, aerogels, mircrosilica, superabsorbers, polyoxometalates, biozides, pharmaceuticals, dyestuffs, colored pigments, white pigments, synthetic polymers, fluorescent pigments, and phosphorescent piments (phosphors), synthetic polymers, lactic acid and polylactides, biopolymers, metals, allotropes of carbon, organic and inorganic acids and bases, oxides, oxidic catalysts, standard sand, organic and inorganic salts, organic and inorganic foams, flame retardants, flame inhibitors, zeolites, precursors for organically modified ceramic materials, conditioned ceramics, dendritic polymers, liquid crystalline polymers, foaming agents, agents for forming air pores, microscale and macroscale fillers, infusorial earths or kieselguhrs, fly ashes, water glass, milled glass, foamed glass, pumice, tuff, lava foam, perlite, vermiculite, latent heat reservoirs, coffee grounds, radicals like TEMPO, radical initiators such as peroxides, C-C-starters and azo compounds, quick binders, quickly setting cement, cement quickening agents, milled porous concrete, milled porous geopolymers and self-healing agents.

Preferably, the at least one additive is contained in the lightweight building material in customary and known amounts. More preferably, the additive is contained in an amount of from 0.01 to <50% by weight, based on the complete weight of a given lightweight construction material of the invention.

In the case of the particularly preferred lightweight construction materials of the invention.
the at least one kind of cement is Portland cement,
the at least one zinc phosphate cement can be prepared from zinc oxide, magnesium oxide, calcium fluoride, silicon dioxide, aluminum oxide and orthophosphoric acid,
the at least one silicate and/or the at least one alumosilicate is or are selected from the group consisting of natural alumosilicates, water glass, kaolinite, metakaolin, slag sand powder, micro silica, trass powder, oil shale, fly ash, wood oven, slag, aluminum containing silicate powder, puzzolans, clays, marl, andesites, diatomaceous earths, Kieselguhrs, zeolites, brick powder and smelting chamber sand,
the at least one alkaline activator is selected from the group consisting of sodium-water glass, potassium-water glass, lithium-water glass, sodium hydroxide, sodium hydroxide solution, potassium hydroxide, sodium carbonate, potassium carbonate, alkaline sulfate, sodium meta silicate and lime wash,
the at least one acidic activator is selected from the group consisting of phosphoric acid, fruit acids and humus acids,
the at least one geopolymer is selected from the group consisting of of a poly(siloxanate) (Si:Al=1:0), a poly(sialate) (Si:Al=1), a poly(sialate-multisiloxanate) (Si:Al=2), a poly(calciumsialate) (Si:Al=1, 2, 3), a poly(sialate-multisiloxanate) (1<Si:AL<5), a poly(siloxanate)(Si:Al>5), a geopolymer on the basis of fly ash, a geopolymer on the basis of iron sialate, a geopolymer on the basis of aluminum phosphate and an organic-mineral geopolymer, and
the at least one surfactant is selected from the group consisting of amphoteric surfactants, bio surfactants, bola-shaped surfactants, co-surfactants, protein surfactants, fluorine surfactants, gemini-surfactants, anionic surfactants, cationic surfactants, non-ionic surfactants, perfluoro surfactants, polymer surfactants, silicon surfactants and triton surfactants.

In even another particularly preferred embodiment, the lightweight construction materials of the invention contain cellulose nanofibers (CNS), micro-fibrillate cellulose (MFC), nanocrystalline cellulose (CNC), bacterial nanocellulose (BNC) and/or microcrystalline cellulose (MCC), preferably in an amount of from 0.001% by weight to 5% by weight, more preferably of from 0.01% by weight to 2.5% by weight, and particularly preferably of from 0.1% by weight to 1% by weight, each weight percentage being based on the dry mass of a given dispersion.

The nanocellulose materials effect a significant improvement of the mechanical properties of the lightweight construction materials of the invention and contribute to a good dispersion in the dispersions of the invention on the one hand and to the stabilization of the foam structures on the other hand. Moreover, they suppress effectively the blooming of materials.

In even another particularly preferred embodiment, the lightweight construction materials of the invention contain cement and/or water glass soaked carbon particles of an average particle size of from 10 nm to 1000 μm.

Preferably, the carbon particles are selected from the group consisting of biochar, pyrogenic charcoal, plant charcoal, wood charcoal, sieve residues of wood charcoal, wood ash, activated charcoal, mineral coals, animal coals, animal waste coals, pyrogenic charcoal of diverse degrees of pyrolysis, functionalized coals, pretreated coals, washed coals and extracted coals. In particular, the biochar and/or the pyrogenic charcoal is or are used. These materials are customary and known and are disclosed, for example, by the German laid-open patent application DE 10 2015 010 041 A1, paragraphs [0055] to [0064].

Preferably, the lightweight construction materials of the invention can contain the soaked or aged carbon particles in the amount of from 0.1% by weight to <50% by weight, each based on the complete weight of a given lightweight building material.

The soaking or aging are customary and known processes and are described, for example, in Salman, Scholze, Keramik, 7. Auflage, Springer, 2006, pages 593 ff.; Fritz Ullmann, Enzyklopädie der technischen Chemie, Band 17, Urban & Schwarzenberg, Wilhelm Foerst; or H. G. Hirschberg, Handbuch Verfahrenstechnik und Anlagenbau Chemie, Technik, Wirtschaftlichkeit, Springer 2013, page 623.

Likewise, the wood shreddings, lignins and/or the polysaccharides can be soaked or aged with cement and/or water glass

Volatile organic compounds (VOCs), toxic substances, heavy metals and unpleasantly smelling compounds can be absorbed by the carbon particles and can be removed, for example, from the air of housing spaces, which is a particular essential advantage.

The lightweight building material of the invention distinguishes itself by a particularly low heat conductivity and a high insulation value W/mK like foamed polystyrene, but it does not need flame retardants like the latter because it is not inflammable and it can be disposed of without problems. Its density is very low, in particular <0.5 kg/cubic decimeter.

In order to obtain the desired shape after the drying, the lightweight construction material of the invention can be processed at will. For example, it can be sanded, sawed, chiseled and/or modified with screws, nails and/or other methods of fixation. It can also be worked on with air streams and water streams.

The resulting lightweight construction materials of the invention, in particular the porous concrete, can have diverse surface structures. They can be a rough and/or smooth or show one structured side and/or multiple structured sides. Moreover, they can have a regular and/or an irregular shape. They can be structured with dots, lines, waves, circles, and/or with and/or in any conceivable shape. Furthermore, they can have a “closed skin” which means that they do not have pores at their surface, but are set. In this case, a smooth surface can be generated in a simple manner by polishing which is an essential advantage.

The lightweight construction materials of the invention, in particular the porous concrete, can be worked on, laminated, lined, impregnated, coated and/or can be sprayed with the above described nanoparticles and/or other materials, as for example, functional materials, additives and/or fillers. Additionally, they can be covered with mediating agents, as for example, wood, cork, burnt clays, tars and/or bitumen. Moreover, they can be made water-repellent and/or watertight by hydrophobic agents like hydrophobin or siloxane.

Furthermore, they can be colored and/or colorless, structured and/or unstructured, sealed or semipermeable and/or permeable, hydrophobic and/or hydrophilic, super-hydrophilic and/or ultra-hydrophilic and/or super-hydrophobic and/or ultra-hydrophobic.

The lightweight construction materials of the invention, in particular the porous concrete, can be extraordinarily widely used. The following list contains no restrictions at all. Thus, they can be used for the control of mold, algae, and bacteria within and without buildings, bridges, lanes, and streets, as mold and bacteria devitalizing shaped parts and building materials of all kinds, floors, floor screeds, insulating materials, potting compounds, substitutes for foams of polyurethanes, expanded polystyrene (EPS) and extruded hard foams (XPS), fundaments, underwater buildings, foam injections for hollow layers, isolating leveling masses, constructions for floor heatings, constructions for flat roofs, plastering for the inside and the outside, brick materials and/or liquid materials, stones and/or shaped stones, supporting and/or non-supporting elements, substitutes for sheetrocks or drywalls, footfall sound protection, fire protection, radiation protection, interior works, facings, walls, ceilings, reinforced ceiling plates, wall tiles, roof tiles, lintels, U-bowls, roller shutter casings, decorative elements, heat insulators, insulating fillings for walls with screwed-on planking, heat insulations for grills and grill installations as such, door fillings for fireproof doors, sandwich constructions and encapsulations, hollow articles, linings and shimmings, underfillings, systems according to the “Lego™-principle”, building parts which do not green after the weathering for many years, walls isolating against electromagnetic radiation and/or magnetic fields, as raw materials for the preparation of cements according to the “Cradle to Cradle”-principle, for the prevention of cold bridges and cold spots as well as for the preparation of composite materials.

In a particularly preferred embodiment, the lightweight construction materials of the invention, in particular the porous concrete, in the shape of building bricks can exhibit holes and/or grooves in order to save material and weights. The building bricks can have indentations and special holes on the one side and on the other side embossed parts, which parts can also consist of another material, as for example plastic so that the building bricks can be tightly stacked on top of each other like Lego™-building blocks.

Hollow shapes made from fired clay, fired brick earth and/or natural stone and/or artificial stone can be used which are filled with the cement foam prepared from precursor of the invention. After the hardening to yield the porous concrete, these composite materials can be used as building materials.

In particular, the lightweight construction materials of the invention can be used for manufacturing other composite materials. The composite materials comprise
at least one layer and/or at least one core of at least one lightweight construction material of the invention and
at least one layer and/or at least one coating containing or consisting of materials, selected from the group consisting of non-reinforced and glass fiber reinforced, carbon fiber reinforced, metal fiber reinforced, textile fiber reinforced, natural fiber reinforced and straw fiber reinforced as well as with plastic mats, metal mats, glass mats and natural fiber mats reinforced, nanoparticles and nanofibers reinforced wet brick earth, dried brick earth, fired brick earth, wet clays, dried clays, fired clays, tars, bitumen, natural asphalt, mineral wax, earth wax, montan wax, coatings, thermoplastic and thermosetting polymers, papers, cardboard materials, cardboard boxes, sheetrock plates, lumbers, cork, metal sheets, glass plates, gypsum plates and layers made from low melting glasses as well as composites consisting of at least two of these materials.

In order to improve the adhesion of the layers in or the coatings on top of the layers or cores consisting of at least one lightweight building material of the invention, the latter can have a structured surface, exhibiting, for examples, grooves, indentations and/or embossed parts.

An additional particular advantage of the lightweight construction material of the invention is that it can be excellently papered.

### EXAMPLES AND COMPARATIVE EXPERIMENTS

### Example 1

### The Preparation of Foamed Concrete and of a Floor Screed

200 g of milled porous concrete, 800 g of Portland cement, 1 g of sodium lauryl sulfate and 1 g of cornstarch in 1 L of water of a water hardness of 4.25 mmol/L were mixed with each other by gentle stirring in an Ultrarurrax for 3 hours. Thereafter, the resulting aqueous, portable, foamable and settable dispersion was foamed during 30 minutes in 5 L beaker. The resulting cement foam was filled into a rectangular, oblong open mold of a free volume of 4 L and was dried therein at room temperature for 12 hours. Thereafter, the resulting block was dried for 3 hours at 80° C. in an oven. The resulting block of porous concrete was taken out of the mold and its application-technical properties were determined. Thus, the block exhibited a pleasing, even, light grey color and a high mechanical stability. Upon skin contact, it gave a warm and smooth and non-scratching impression. However, it is essential, that it showed a density of 0.3 kg/L so that it was buoyant. Besides that, the porous concrete block exhibited an advantageously high elasticity and hardness. The porous concrete block could be sawed easily without the development of larger amounts of dust. It was an essential advantage, that the resulting dust was not toxic and, in particular, contained no fine aluminum particles. The porous concrete block could be used advantageously as a lightweight construction material, in particular as an insulating material. Especially, it could be used as a heat insulation, a cold insulation and an electrical insulation. If necessary, it could be disposed of without problems.

Another lot of the aqueous, portable and settable cement foam was prepared in accordance with the specification set out above. The cement foam was poured onto the surface of a room floor made of concrete. In doing so, the cement foam turned out to be self-leveling so that it forms an even and smooth, porous, 3 cm thick, excellently heat insulating, walkable, insulating floor screed after a drying time of 3 days at the air, which floor screed could be coated with a polymeric hermetic sealing without a mold formation due to residual moisture.

In order to concretely demonstrate the excellent insulating properties of the porous concrete of the invention, a porous concrete block of a height of 20 cm, a length of 30 cm and a width of 15 cm was hollowed out centrally so that an indentation resulted, wherein the 4 vertical sidewalls had a thickness of 2.5 cm each and the bottom had of thickness of 3 cm. The indentation was filled with methylated spirit and the spirit, was ignited. Despite the high temperatures which developed inside the indentation, the sidewalls could be touched with bare hands without problems so that the porous concrete block with the burning methylated spirit could be carried without problems to another location by hand.

### Example 2

### The Preparation of an Aqueous, Pourable, Foamable and Settable Dispersion and its Use

200 g of milled porous concrete, 800 g of Portland cement and 1 g of sodium lauryl sulfate, 2.5 g of polycarboxylic ether according to Example 5, page 10, paragraph [0069] of DE 10 2007 045 230 A1 and 1.5 g of corn starch and 1 L of water having water hardness of 4.25 mmol/L were mixed with each other with an Ultraturrax in a 5 L beaker by gentle stirring for 3 hours. Thereafter, the resulting aqueous, pourable, foamable and settable dispersion was foamed with intensive stirring for 30 minutes. The resulting aqueous, pourable and settable cement foam was left standing for 4 hours and was still flowable, pourable and sprayable. Its particular advantages showed when used as door fillings, as for example, for fire protection doors, for wall injections, in particular, for purposes of fire protection, and as floor screed.

### Example 3

### The Preparation of Aqueous, Pourable, Foamable and Settable Dispersions and their Use

Liquid cement containing no surfactant and no starch was transported with a cement truck to its location of use. At the location, 0.5% by weight of technical sodium lauryl sulfate and 0.5% by weight of corn starch, each based on the dry mass of the liquid cement, were added. The surfactant, the cornstarch and the liquid cement were mixed which each other in the cement mixer for 2 hours. Thereafter, the resulting aqueous, pourable, foamable and settable dispersion was pumped into a mixer, wherein it was foamed with intensive stirring. The resulting aqueous, pourable, pumpable and settable cement foam was pumped behind the removable boarding in front of room walls. The gaps between the removable boarding and the room walls had a width of 1 cm. The resulting layers of foam cement were dried at room temperature during 6 days. Thereafter, the boarding was removed. The resulting closed cell layers of cement foam had a thickness of 1 cm and were thermally insulating and not inflammable. They also showed very good vapor diffusion properties so that no mold was formed even after a long service life.

It was surprising that the layer of hardened cement foam could be papered directly.

### Example 4

### The Manufacture of Composite Materials, in Particular Composite Building Materials

The self-leveling cement foam of the Example 2 was prepared as therein described, and poured into flat open molds of fired clay, each with a square, 1 m² measuring and 3 cm deep indentation and dried therein. The free surfaces of the resulting porous concrete plates were coated with an even layer of unfired clay. Thereafter, the composite building materials were fired. The composite building materials were taken from the clay molds. They had a smooth and even clay surface which could be very well coated with bitumen. The bitumen layers adhered very well to the clay surfaces so that the platelike composite building materials were excellently suited for covering flat roofs.

The self-leveling cement foam was prepared as described in the Example 2 and poured into flat open molds of fired clay each having a square, 1 m² measuring and 3 cm deep indentation and dried therein. The free surfaces of the resulting porous concrete plates were covered with 0.5 cm thick, wet brick earth layers. Fiber mats made from natural fibers of a thickness of 0.2 cm were placed holohedrally into the brick earth layers. Thereafter, the fiber mats made from natural fibers were covered with another 0.5 cm thick wet brick earth layer. The brick earth layers thus reinforced were dried slowly at the air. Thereafter, they were taken from the clay molds. The resulting composite building materials were excellently suited as wallcoverings for interior walls of rooms. Due to their capability to take up and to release water, they could effectively prevent the formation of mold. Due to their diffusion properties and their capability to adsorb noxious agents, they contributed essentially to a healthy room climate so that allergenic and asthmatic persons were free of ailments in these rooms.

### Example 5 and Comparative Experiments 1 and 2

### The Preparation of Aqueous, Pourable, Foamable, Pumpable and Settable Dispersions

200 g of milled porous concrete, 800 g of Portland cement and 1 g of sodium lauryl sulfate, 2.5 g of polycarboxylic ether according to Example 5, page 10, paragraph [0069] of DE 10 2007 045 230 Al and 1.5 g of corn starch in 1 L of water having a water hardness of 4.25 mmol/L were mixed with each other with an Ultraturrax in a 5 L beaker by gentle stirring for 3 hours.

As a comparison, the experiment was repeated with fully deionized water (Comparative Experiment 1).

The Comparative Experiment 1 was repeated only that 4 mmol/L of magnesium ions were added to the deionized water (Comparative Experiment 2).

Thereafter, the resulting aqueous, pourable, foamable, pumpable and settable dispersions were foamed with intensive stirring for 30 minutes. The resulting aqueous, pourable and settable cement foams were left standing for 4 hours and were still flowable, pourable and sprayable. After that time period, they were poured into 200 ml plastic beakers and were hardened at the air at room temperature for 3 days.

Whereas all samples with the cement foam according to the Example 5 yielded porous concrete blocks with an even and smooth horizontal surface, the porous concrete blocks prepared from the cement foam according to the Comparative Experiment 1 showed trough-shaped surfaces which were afflicted with fractions. Therefore, soft water was completely unsuited for the manufacture of porous mineral lightweight construction materials.

The dispersion of the Comparative Experiment 2 did not form a stable foam upon foaming. Therefore, it was completely unsuited for the manufacture of porous, mineral lightweight construction materials.

### Example 6

### The Weathering of Porous Concrete Blocks According to Example 1

5 porous concrete blocks having a height of 40 cm, a length of 50 cm and a width of 30 cm were prepared in accordance with the prescription of the Example 1. The porous concrete blocks were subjected to weathering at an exposed location for 2 years. They showed no greening, i.e. no growth of moss, algae and lichens, even after this long time period.

### Example 7

### The Manufacture of Porous Concrete and Floor Screed

Example 1 was repeated only that, instead of 800 g of Portland cement a mixture of 400 g of poly(siloxanate) (Si:Al=1) and 400 g of Portland cement were used. The same advantageous properties as described in the Example 1 were achieved.

### Example 8

### The Preparation of Carbon Containing Porous Concrete and its Use for the Detoxification of Room Air

2 kg of milled porous concrete, 8 kg of Portland cement, 10 g of sodium lauryl sulfate, 10 g of cornstarch and 100 g of pyrogenic carbon having an average particle size of 100 μm were mixed with each other in 10 L of water with gentle stirring. Thereafter, the resulting aqueous, pourable, foamable, pumpable and settable dispersion was foamed in a rapid mixer and in doing so, air was blown through. The foamed dispersion was poured on the concrete floors of a building where they formed self-leveling layers of a thickness of 2 cm. The layers were dried at room temperature for 5 days and formed a 3 cm thick closed cell insulating floor screed which was already walkable and excellently heat insulating. By measurements of the room air and by examinations of the insulating floor screed, it could be established that the floor screed absorbed noxious agents, in particular, nitrogen oxides and VOC, from the room air and the concrete. The noxious agents were degraded by bacteria in the pyrogenic carbon to yield innocuous products. All in all, the room air was improved effectively and permanently by the insulating floor screed.

### Example 9

### The Preparation of Polyoxometalate and Carbon Containing Porous Concrete and its Use for the Detoxification of the Laboratory Air in a Chemical Laboratory

2 kg of milled porous concrete, 8 kg of Portland cement, 10 g of sodium lauryl sulfate, 10 g of cornstarch, 100 g of pyrogenic carbon having an average particle size of 100 μm and 50 g of H₄[Si(W₃O₁₀)₄]. xH₂O (CAS-number 12027-43-9) were mixed with each other in 10 L of water having a water hardness or 4.5 mmol/L with gentle stirring for 5 hours. Thereafter, the resulting aqueous, pourable, foamable, pumpable and settable dispersion was foamed in a rapid mixer and air was blown through at the same time. The foamed dispersion was poured onto the concrete floors of a building, where it formed self-leveling layers of a thickness of 3 cm. The layers were dried for 5 days at room temperature and formed a 3 cm thick closed cell insulating floor screed having excellent heat insulating properties and was already walkable. By measurements of the room air and by examinations of the insulating floor screed, it could be established that the insulating floor screed absorbed noxious agents, in particular, nitrogen oxides and VOC from the air and from the concrete. These noxious agents were degraded to yield innocuous products by the bacteria in the pyrogenic carbon. The oxidative degradation of the noxious carbons was accelerated by the polyoxometalate, and the bactericidal effects of the insulating floor screed was intensified. All in all, the laboratory air was effectively and permanently detoxified and improved by the insulating floor screed.

1-16. (canceled)

17. A process for making a porous, mineral lightweight construction material, the process comprising
preparing at least one chemical precursor by mixing in a mixer
at least one kind of cement,
at least one kind of surfactant,
0.01% by weight to 5% by weight, based on the dry mass of the at least one chemical precursor, of at least one kind of natural homoglycane selected from the group consisting of potato starch, rice starch, cornstarch, and read starch and of cooked and/or raw shredded pieces of grains, potatoes and rice, and
an amount of water having hardness >4 mmol/L, wherein the hardness is either present from the start or is adjusted by dosing alkaline earth carbonates,
thus providing at least one foamed chemical precursor;
performing at least one of steps:
(a) pouring the at least one foamed chemical precursor into at least one structure selected from the group consisting of molds, cavities, fissures and cracks,
(b) applying the at least one foamed chemical precursor onto a surface, and
(c) spraying the at least one foamed chemical precursor onto a surface; and
drying the at least one foamed chemical precursor at a temperature of 20° C. to 100° C. in air for 3 to 48 hours.

18. The process according to claim 17, wherein the kind of cement is Portland cement.

19. The process according to claim 17, wherein the at least one kind of surfactant is selected from the group consisting of amphoteric surfactant, bio surfactant, bola-shaped surfactant, co-surfactant, protein surfactant, fluorine surfactant, gemini-surfactant, anionic surfactant, cationic surfactant, non-ionic surfactant, perfluoro surfactant, polymer surfactant, silicon surfactant and triton surfactant.

20. The process according to claim 17, wherein the at least one kind of surfactant is selected from the group consisting of decyl-, undecyl-, dodecyl-(lauryl-), tridecyl-, tetradecyl-, pentadecyl-, hexadecyl-, hexadecyl-octadecyl-, nonadecyl-, and eicosanyl-sulfate, ethersulfate, phosphate, sulfonate and sulfoacetate and corresponding salt, free acid, ester, amide, halide, and anhydride thereof.

21. The process according to claim 17, wherein the at least one kind of natural homoglycane is contained in an amount of from 0.01 to 5% by weight, based on the dry mass of the at least one chemical precursor.

22. The process according to claim 17, wherein the at least one kind of natural homoglycane is corn starch.

23. The process according to claim 17, wherein the at least one chemical precursor contains at least one additive selected from the group consisting of synthetic polysaccharide, natural polysaccharide, modified natural polysaccharide, polysaccharide, superliqifier, water reducing agent, rheological additive, nano, micro and macro fiber, nanoparticle, microparticle, milled bamboo, hydrolyzed bamboo, phyllosilicate, brick earth, clay, aerogel, microsilica, silica gel, superabsorber, polyoxometalate, biocide, pharmaceutical, dyestuff, colored pigment, white pigment, fluorescent pigment and phosphorescent pigment (phosphor), synthetic polymer, biopolymer, metal, organic acid, inorganic acid, organic base, inorganic base, oxide, standard sand, organic salt, inorganic salt, organic foam, inorganic foam, flame retardant, flame inhibitor, zeolite, precursor for organically modified ceramic material, processed ceramic material, microscale filler, macroscale filler, infusorial earth, fly ash, water glass, ground glass, quick binders, fast cement, cement accelerator, milled porous concrete and self-healing agent.

24. The process according to claim 17, wherein the porous, mineral lightweight construction material is comprised in one selected from the group consisting of floor, insulating material, casting compound, substitutes for PUR-foam plate, fundament, foam injection for hollow layer, isolating adjustment material, installation for floor heating, installation for flat roof, inside plasterwork, outside plasterwork, block material, liquid material, stone, shaped stone, supporting element, non-supporting element, sheetrock substitute, footfall sound protection, fire protection, radiation protection, interior work, facing, wall, ceiling, reinforced ceiling plate, roof plate, lintel, U-shaped bowl, roller shutter boxe, decorative element, heat insulator, door filling for fire protection door, sandwich construction encapsulation, hollow article, self-leveling mass, filler mass, lining, under filling, LEGO™-principal system, wall isolating against electromagnetic radiation, and wall for the prevention of thermal bridge and cold spot.

25. The process according to claim 24, wherein the shaped stone have at least one element selected from the group consisting of groove, spring, tongue-and-groove joint, and grip recess.

26. The process according to claim 24, further comprising plastering the porous, mineral lightweight construction material to become hydrophobic and/or smooth.
